(19) United States
(12) Patent Application Publication
(10) Pub. No.: US 2014/0360367 A1
(43) Pub. Date: Dec. 11, 2014

(54) ORGANOPOLYSILOXANES INCLUDING SILICON-BONDED TRIALKYLSILYL-SUBSTITUTED ORGANIC GROUPS

(71) Applicant: Dow Corning Corporation, Midland, MI (US)

(72) Inventors: Dongchan Ahn, Midland, MI (US); James S. Hrabal, St. Louis, MI (US); Alexandra N. Lichtor, Midland, MI (US)

(21) Appl. No.: 14/366,593

(22) PCT Filed: Dec. 27, 2012
(86) PCT No.: PCT/US2012/071834

§ 371 Date: Jun. 18, 2014

Related U.S. Application Data
(60) Provisional application No. 61/580,434, filed on Dec. 27, 2011.
(60) Provisional application No. 61/580,437, filed on Dec. 27, 2011.

(51) Int. Cl. B01D 71/70; B01D 69/08; B01D 69/00; B01D 69/04; C08G 77/38; B01D 53/22

(52) U.S. Cl. CPC B01D 71/70; C08G 77/38; B01D 53/22; B01D 69/00; B01D 69/04; B01D 69/08; B01D 2053/221; B01D 2053/224
USPC 95/45; 528/31; 524/862; 96/4; 96/10; 96/11

(57) ABSTRACT

This invention relates to organopolysiloxane compounds. In some embodiments, the organopolysiloxane compound includes a siloxane unit having at least one trialkylsilyl pendant group attached thereto through an organic group spacer. The present invention also relates to methods of making the organopolysiloxane, a hydrosilylation-curable silicone composition including the organopolysiloxane, a cured product of the silicone composition, a membrane including the cured product, a method of making the membrane, and a method of separating components in a feed mixture using the membrane.

### CLAIM OF PRIORITY

This application claims the benefit of priority of U.S. Patent Application Ser. No. 61/580,434, entitled “ORGANOPOLYSILOXANES INCLUDING SILICON-BONDED TRIALKYLSILYL-SUBSTITUTED ORGANIC GROUPS,” filed on Dec. 27, 2011, and of U.S. Patent Application Ser. No. 61/580,437, entitled “HIGH FREE VOLUME SILOXANE COMPOSITIONS USEFUL AS MEMBRANES,” filed on Dec. 27, 2011, which applications are incorporated by reference herein in its entirety.

Organopolysiloxanes are versatile compounds. Organopolysiloxanes can be used to form a composition that includes the organopolysiloxane, which can then be allowed to undergo a chemical reaction, resulting in a reaction product generated from the organopolysiloxane. In some examples, the reaction product or the organopolysiloxane itself can have properties that give it myriad applications, including use in personal care products like cosmetics, deodorant, food, and soaps, and other applications including wave guides, sealants, coatings, lubricants, fire-resistant materials, defoamers, pharmaceutical additives, structural products for plumbing and building construction, toys, paints, and membranes that can be used for separations.

Artificial membranes can be used to perform separations on both a small and large scale, which makes them very useful in many settings. For example, membranes can be used to purify water, to cleanse blood during dialysis, and to separate gases or vapors. Some common driving forces used in membrane separations are pressure gradients and concentration gradients. Membranes can be made from polymeric structures, for example, and can have a variety of surface chemistries, structures, and production methods. Membranes can be made by hardening or curing a composition.

### SUMMARY OF THE INVENTION

The present invention relates to organopolysiloxanes. In some examples, the organopolysiloxanes include silicon-bonded trialkylsilyl-substituted organic groups. In one embodiment, the present invention relates to an organohydrogenpolysiloxane containing a plurality of silicon-bonded trialkylsilyl-substituted organic groups. The present invention also relates to a hydrosilylation-curable silicone composition including the organopolysiloxane, a cured product of the silicone composition, a membrane including the cured product, a method of making the membrane, and a method of separating gas components in a feed gas mixture using the membrane.

Various embodiments of the organopolysiloxane of the present invention including silicon-bonded trialkyl-substituted organic groups can be used to generate materials with beneficial and unexpected properties, for example, membranes with high permeability for particular gases and vapors, and can feature high selectivity for particular gases and vapors. In some embodiments, the organopolysiloxanes of the present invention can have high free volume, which gives rise to high gas permeability, making them useful for membrane applications where a high flux of a certain gas is in a mixture is beneficial for purification or other modification of a gas mixture. In some embodiments, the organopolysiloxane of the present invention can have significantly different thermal properties from conventional polymers. Some embodiments show no evidence of crystallinity and therefore can offer unique thermomechanical properties. Some embodiments further show a high glass transition temperature, for example higher than that of PDMS, providing a modified viscoelastic and thermomechanical profile that can be advantageous for membrane processing or contribute to enhanced mechanical strength. In various embodiments, the membranes of the present invention can exhibit high permeability for particular gases, while retaining good selectivity for particular gases, such as particular gas components of a mixture. In some examples, the membranes of the present invention can exhibit advantageous thermal or mechanical properties while retaining high CO₂/N₂ selectivity and high permeability of PDMS. In some examples, the membranes of the present invention can exhibit high fractional free volume. In some embodiments, the membranes of the present invention can exhibit high water vapor permeability, making them potentially useful as a means to humidify or dehumidify air. In some examples, the membranes of the present invention can have advantageous mechanical properties, for example compared to PDMS membranes, such as increased strength. In some embodiments, the membrane of the present invention advantageously has a fractional free volume higher than those made from PDMS when calculated by the method of Bondi. For example, the fractional free volume can be greater than 0.20 when calculated by the method of Bondi.

In various embodiments, the present invention provides an organopolysiloxane. The organopolysiloxane includes siloxane units. About 5 to about 100 mol % of the siloxane units are bound to at least one trialkylsilyl-substituted organic group. The organopolysiloxane has a number-average molecular weight of about 2,000 to about 2,000,000 g/mol.

In various embodiments, the present invention provides a hydrosilylation-curable silicone composition. The hydrosilylation-curable silicone composition includes (A) an organohydrogenpolysiloxane. The organohydrogenpolysiloxane includes siloxane units. About 5 to about 99.99 mol % of the siloxane units are bound to at least one trialkylsilyl-substituted organic group. About 0.01 to about 30 mol % of the siloxane units are bound to at least one hydrogen atom. The organopolysiloxane has a number-average molecular weight of about 2,000 g/mol to about 2,000,000 g/mol. The hydrosilylation-curable silicone composition also includes (B) a compound having an average of at least two aliphatic unsaturated carbon-carbon bonds per molecule. Component (B) is selected from (i) at least one organosilicon compound having an average of at least two aliphatic unsaturated carbon-carbon bonds per molecule, (ii) at least one organic compound having at an average of at least two aliphatic unsaturated carbon-carbon bonds per molecule, and (iii) mixtures including (i) and (ii). The hydrosilylation-curable silicone composition also includes (C) a hydrosilylation catalyst. The ratio of the moles of silicon-bonded hydrogen atoms in Component (A) to the sum of the number of moles of aliphatic unsaturated carbon-carbon bonds in the composition is about 0.1 to about 20.

Various embodiments of the present invention provide a method of separating gas components in a feed gas mixture. The method includes contacting a first side of a membrane including a cured product of a hydrosilylation-curable silicone composition with a feed gas mixture. The feed gas mixture includes at least a first gas component and a second gas component. The contacting produces a permeate gas mixture on a second side of the membrane and a retentate gas mixture on the first side of the membrane. The permeate gas mixture is enriched in the first gas component and the retentate gas mixture is depleted in the first gas component. The hydrosilylation-curable silicone composition includes (A) an organohydrogenpolysiloxane including siloxane units. About 20 to about 99.99 mol % of the siloxane units are bound to at least one trialkylsilyl substituted organic group. About 0.01 to about 30 mol % of the siloxane units are bound to at least one silicon-bonded hydrogen atom. The organopolysiloxane has a number-average molecular weight of about 3,500 to about 100,000 g/mol. The hydrosilylation-curable silicone composition also includes (B) a compound having an average of at least two aliphatic unsaturated carbon-carbon bonds per molecule. Component (B) is selected from (i) at least one organosilicon compound having an average of at least two aliphatic unsaturated carbon-carbon bonds per molecule, (ii) at least one organic compound having at an average of at least two aliphatic unsaturated carbon-carbon bonds per molecule, and (iii) mixtures including (i) and (ii). The hydrosilylation-curable silicone composition also includes (C) a hydrosilylation catalyst. The ratio of the moles of silicon-bonded hydrogen atoms in Component (A) to the sum of the number of moles of aliphatic unsaturated carbon-carbon bonds in the composition is about 0.1 to about 20. The membrane has a water vapor permeability of about 5,000 to about 100,000 Barrer at about 22° C.

### BRIEF DESCRIPTION OF THE FIGURES

In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various embodiments discussed in the present document.

FIG. 1 illustrates a differential scanning calorimetry spectrum of a reaction product of Example 1, in accordance with various embodiments.

FIG. 2 illustrates a differential scanning calorimetry spectrum of a reaction product of Example 2, in accordance with various embodiments.

FIG. 3 illustrates a differential scanning calorimetry spectrum of a reaction product of Comparative Example C1.

### DETAILED DESCRIPTION OF THE INVENTION

Reference will now be made in detail to certain embodiments of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

In the methods of manufacturing described herein, the steps can be carried out in any order without departing from the principles of the invention, except when a temporal or operational sequence is explicitly recited. Furthermore, specified steps can be carried out concurrently unless explicit claim language recites that they be carried out separately. For example, a claimed step of doing X and a claimed step of doing Y can be conducted simultaneously within a single operation, and the resulting process will fall within the literal scope of the claimed process.

The term “about” can allow for a degree of variability in a value or range, for example, within 10%, within 5%, or within 1% of a stated value or of a stated limit of a range.

The term “organic group” as used herein refers to but is not limited to any carbon-containing functional group. Examples include acyl, cycloalkyl, aryl, aralkyl, heterocyclyl, heteroaryl, or heteroarylalkyl, linear and/or branched groups such as alkyl groups, fully or partially halogen-substituted haloalkyl groups, alkenyl groups, alkynyl groups, acrylate and methacrylate functional groups; and other organic functional groups such as ether groups, cyanate ester groups, ester groups, carboxylate salt groups, and masked isocyano groups.

The term “substituted” as used herein refers to an organic group as defined herein or molecule in which one or more hydrogen atoms contained therein are replaced by one or more non-hydrogen atoms. The term “functional group” or “substituent” as used herein refers to a group that can be or is substituted onto a molecule, or onto an organic group. Examples of substituents or functional groups include, but are not limited to, any organic group, a halogen (e.g., F, Cl, Br, and I); a sulfur atom in groups such as thiol groups, alkyl and aryl sulfide groups, sulfoxide groups, sulfone groups, sulfonyl groups, and sulfonamide groups; a nitrogen atom in groups such as amines, hydroxylamines, nitriles, nitro groups, N-oxides, hydrazides, azides, and enamines; and other heteroatoms in various other groups.

The term “alkyl” as used herein refers to straight chain and branched alkyl groups and cycloalkyl groups having from 1 to about 20 carbon atoms, and typically from 1 to 12 carbons or, in some embodiments, from 1 to 8 carbon atoms. Examples of straight chain alkyl groups include those with from 1 to 8 carbon atoms such as methyl, ethyl, n-propyl, n-butyl, n-pentyl, n-hexyl, n-heptyl, and n-octyl groups. Examples of branched alkyl groups include, but are not limited to, isopropyl, isobutyl, sec-butyl, t-butyl, neopentyl, isopentyl, and 2,2-dimethylpropyl groups. As used herein, the term “alkyl” encompasses all branched chain forms of alkyl. Representative substituted alkyl groups can be substituted one or more times with any functional group, for example, amino, hydroxy, cyano, carboxy, nitro, thio, alkoxy, and halogen groups.

The term “alkenyl” as used herein refers to straight and branched chain and cyclic alkyl groups as defined herein, except that at least one double bond exists between two carbon atoms. Thus, alkenyl groups have from 2 to about 20 carbon atoms, and typically from 2 to 12 carbons or, in some embodiments, from 2 to 8 carbon atoms. Examples include, but are not limited to vinyl, —CH═CH(CH3), —CH═C(CH3)2, —C(CH3)=CH2, —C(CH3)=CH(CH3), —C(CH2CH3)=CH2, cyclohexenyl, cyclopentenyl, cyclohexadienyl, butadienyl, pentadienyl, and hexadienyl, among others.

The term “aryl” as used herein refers to cyclic aromatic hydrocarbons that do not contain heteroatoms in the ring.

The term “resin” as used herein refers to polysiloxane material of any viscosity that includes at least one siloxane monomer that is bonded via a Si—O—Si bond to three or four other siloxane monomers. In one example, the polysiloxane material includes T or O groups, as defined herein.

The term “radiation” as used herein refers to energetic particles travelling through a medium or space. Examples of radiation are visible light, infrared light, microwaves, radio waves, very low frequency waves, extremely low frequency waves, thermal radiation (heat), and black-body radiation.

The term “cure” as used herein refers to exposing to radiation in any form, heating, or allowing to undergo a physical or chemical reaction that results in hardening or an increase in viscosity.

The term “free-standing” or “unsupported” as used herein refers to a membrane with the majority of the surface area on each of the two major sides of the membrane not contacting a substrate, whether the substrate is porous or not. In some embodiments, a membrane that is “free-standing” or “unsupported” can be 100% not supported on both major sides. A membrane that is “free-standing” or “unsupported” can be supported at the edges or at the minority (e.g. less than about 50%) of the surface area on either or both major sides of the membrane.

The term “supported” as used herein refers to a membrane with the majority of the surface area on at least one of the two major sides contacting a substrate, whether the substrate is porous or not. In some embodiments, a membrane that is “supported” can be 100% supported on at least one side. A membrane that is “supported” can be supported at any suitable location at the majority (e.g. more than about 50%) of the surface area on either or both major sides of the membrane.

The term “selectivity” or “ideal selectivity” as used herein refers to the ratio of permeability of the faster permeating gas over the slower permeating gas, measured at room temperature.

The term “permeability” as used herein refers to the permeability coefficient (PX) of substance X through a membrane, where qmX=PX*A*ΔpX*(1/delta), where qmX is the volumetric flow rate of substance X through the membrane, A is the surface area of one major side of the membrane through which substance X flows, ΔpX is the pressure difference of the partial pressure of substance X across the membrane, and delta is the thickness of the membrane. Unless otherwise specified, the permeability coefficients cited refer to those measured at ambient laboratory temperatures, e.g. 22±2° C.

The term “Barrer” or “Barrers” as used herein refers to a unit of permeability, wherein 1 Barrer=10⁻¹¹ (cm³ gas) cm cm⁻² s⁻¹ mmHg⁻¹, or 10⁻¹⁰ (cm³ gas) cm cm⁻² s⁻¹ cm Hg⁻¹, where “cm³ gas” represents the quantity of the gas that would take up one cubic centimeter at standard temperature and pressure.

The term “total surface area” as used herein with respect to membranes refers to the total surface area of the side of the membrane exposed to the feed gas mixture.

The term “room temperature” as used herein refers to ambient temperature, which can be, for example, between about 15° C. and about 28° C.

The term “coating” refers to a continuous or discontinuous layer of material on the coated surface, wherein the layer of material can penetrate the surface and can fill areas such as pores, wherein the layer of material can have any three-dimensional shape, including a flat or curved plane. In one example, a coating can be formed on one or more surfaces, any of which may be porous or nonporous, by immersion in a bath of coating material.

The term “surface” refers to a boundary or side of an object, wherein the boundary or side can have any perimeter shape and can have any three-dimensional shape, including flat, curved, or angular, wherein the boundary or side can be continuous or discontinuous.

The term “mil” as used herein refers to a thousandth of an inch, such that 1 mil=0.001 inch.

The term “crosslinking agent” as used herein refers to any compound that can chemically react to link two other compounds together. The chemical reaction can include hydrosilylation.

The term “silane” as used herein refers to any compound having the formula Si(R)4, wherein R is independently selected from any hydrogen, halogen, or optionally substituted organic group; in some embodiments, the organic group can include an organosubstituted siloxane group, such as an organomonosiloxane group, while in other embodiments, the organic group does not include a siloxane group. In some embodiments, one or more R groups in the formula Si(R)4 is a hydrogen atom. In other embodiments, one or more R groups in the formula Si(R)4 is not a hydrogen atom.

The term “number-average molecular weight” as used herein refers to the ordinary arithmetic mean or average of the molecular weight of individual molecules. It can be determined by measuring the molecular weight of n polymer molecules, summing the weights, and dividing by n.

The phrase “hydrosilylation-reactive components of the uncured composition” as used herein can include, for example, compounds having Si—H bonds, compounds including aliphatic unsaturated carbon-carbon bonds, and hydrosilylation catalyst.

The term “enrich” as used herein refers to increasing in quantity or concentration, such as of a liquid, gas, or solute. For example, a mixture of gases A and B can be enriched in gas A if the concentration or quantity of gas A is increased, for example by selective permeation of gas A through a membrane to add gas A to the mixture, or for example by selective permeation of gas B through a membrane to take gas B away from the mixture.

The term “deplete” as used herein refers to decreasing in quantity or concentration, such as of a liquid, gas, or solute. For example, a mixture of gases A and B can be depleted in gas B if the concentration or quantity of gas B is decreased, for example by selective permeation of gas B through a membrane to take gas B away from the mixture, or for example by selective permeation of gas A through a membrane to add gas A to the mixture.

### I. Organopolysiloxane Containing at Least One Silicon-Bonded Trialkylsilyl-Substituted Organic Group

The present invention provides an organopolysiloxane that includes a silicon-bonded trialkylsilyl-substituted organic group. The organopolysiloxane can include any suitable organopolysiloxane that includes at least one suitable silicon-bonded trialkylsilyl-substituted organic group.

The organopolysiloxane compound can be any suitable organopolysiloxane compound. In one embodiment, the organopolysiloxane has an average of about 5 to 100 mol % of the siloxane units bearing at least one trialkylsilyl substituted organic group. In some embodiments, in the organopolysiloxane, the organopolysiloxane can have an average of about 5 mol % to 100 mol %, or about 10, 20, 30, 40, 50, 60, 70, 80 mol % to about 100 mol %, or about 90 mol % to 100 mol % of the siloxane units are bound to at least one trialkylsilyl substituted organic group.

In some embodiments, the organopolysiloxane has a number average molecule weight of about 2,000 g/mol to 2,000,000 g/mol. In some examples, the organopolysiloxane has a number average molecular weight of about 2,000 g/mol to 20,000 g/mol, about 3,500 g/mol, 6,000 g/mol, 10,000 g/mol, or about 15,000 g/mol to 20,000 g/mol. In some examples, the organopolysiloxane has a number average molecular weight of about 10,000 g/mol to about 100,000 g/mol, or about 30,000 g/mol, 40,000 g/mol, 50,000 g/mol, or about 75,000 gμmol to 100,000 gμmol. In some examples, the organopolysiloxane has a number average molecular weight of about 60,000 g/mol to 500,000 g/mol, about 100,000 g/mol to 500,000 g/mol, or about 300,000 g/mol to 500,000 g/mol.

In some embodiments, the organopolysiloxane containing silicon-bonded organic groups can be an organohydrogenpolysiloxane. In some embodiments, the organohydrogenpolysiloxane has between about 0.001 mol % to 50 mol % of the siloxane units bearing at least one silicon-bonded hydrogen atom. In some examples, the organohydrogenpolysilioxane has between about 0.01 mol % to 40 mol %, 0.01 mol % to 30 mol %, 0.01 mol % to 20 mol %, 0.01 mol % to 10 mol %, 0.01 mol % to 5 mol %, 0.01 mol % to 2 mmol %, or about 0.01 mol % to 1 mol % of the siloxane units bearing at least one silicon-bonded hydrogen atom.

The organopolysiloxane can be a disiloxane, trisiloxane, or polysiloxane. The structure of the organosilicon compound can be linear, branched, cyclic, or resinous. Cyclosiloxanes can have from 3 to 12 silicon atoms, alternatively from 3 to 10 silicon atoms, alternatively from 3 to 5 silicon atoms. In acyclic polysiloxanes, the silicon-bonded trialkylsilyl-substituted organic groups can be located at terminal, pendant, or at both terminal and pendant positions.

In some embodiments, the organopolysiloxane that includes a silicon-bonded trialkylsilyl-substituted organic group is an organopolysiloxane of the formula

R^{y}₃SiO(R^{y}₂SiO)_{α}(R^{y}R²SiO)_{β}SiR^{y}₃, (a)

R^{y}₂R⁴SiO(R^{y}₂SiO)_{χ}(R^{y}R⁴SiO)_{δ}SiR^{y}₂R⁴, (b)

or combinations thereof.

In formula (a), a has an average value of 0 to 2000, and β has an average value of 1 to 10000. Each R^{y} is independently a monovalent functional group, including but not limited to, halogen, hydrogen, or an organic group such as acrylate; alkyl; alkoxy; halogenated hydrocarbon; alkenyl; alkynyl; aryl; heteroaryl; and cyanoalkyl. Each R² is independently a trialkylsilyl-substituted organic group, as described herein, H, or R^{y}.

In formula (b), χ has an average value of 0 to 2000, and δ has an average value of 1 to 10000. Each R^{y} is independently as defined above, and R⁴ is independently the same as defined for R² above.

Examples of organopolysiloxanes having at least one silicon-bonded trialkylsilyl-substituted organic group include compounds having the average unit formula

(R¹R²R³SiO_{1/2})ₐ(R⁴R⁵SiO_{2/2})_{b}(R⁶SiO_{3/2})_{c}(SiO_{4/2})_{d} (I)

wherein each of R¹, R², R³, R⁴, R⁵, and R⁶ is an organic group independently selected from H, R^{y}, and trialkylsilyl-substituted organic groups, as defined herein, 0≦a<0.95, 0≦b<1, 0≦c<1, 0≦d<0.95, a+b+c+d=1.

### Silicon-Bonded Trialkylsilyl-Substituted Organic Group

In some embodiments, the silicon-bonded trialkylsilyl-substituted organic groups have the formula

R^{1a}₃Si—(R^{2a})_{c}—CHR^{3a}CR^{4a}₂—, or

R^{1a}₃Si—(R^{2a})_{c}—C(R^{3a})(CHR^{4a}₂)—,

wherein R^{1a} is independently an organic group such as C₁ to C₄ alkyl, R^{2a} is independently a divalent organic group or a siloxy group having the structure —O—Si(R^{1b})₂— wherein R^{1b} is independently C₁₋₁₀ alkyl or tri(C₁₋₁₀)alkylsiloxy, each of R^{3a} and R^{4a} is independently C₁₋₁₀ hydrocarbyl or H, and c is 0, 1, 2, 3, 4, 5, 6, 7, 8, 9, or 10. In some examples R^{1a}, R^{1b}, R^{2a}, R^{3a} or R^{4a} can be halogen substituted. In the backbone of the linking group leading from the trialkylsilyl group to the organopolysiloxane silicon atom, a single siloxane group can be present; thus, if c=1, R^{2a} can be a siloxy group, and if c is greater than 1, one of the independently selected multiple R^{2a} can be a siloxy group. Multiple siloxy groups can occur in the linking group if they are appended to rather than part of the backbone; thus, if R^{2a} is a siloxy group, R^{1b} can independently be a trimethylsiloxy group, for example. In some embodiments, multiple siloxane groups can be excluded from the backbone of the linking group leading from the trialkylsilyl group to the organopolysiloxane silicon atom. R^{1b} can independently include a single siloxy group; in various embodiments, multiple siloxane groups can independently be excluded from R^{1b}.

In some embodiments, the silicon-bonded trialkylsilyl-substituted organic groups can have the formula

R^{1a}_{d}Si[(R^{2a})_{c}—CHR^{3a}CR^{4a}₂-]ₑ,

R^{1a}_{d}Si[(R^{2a})_{c}—C(R^{3a})(CHR^{4a}₂)-]ₑ, or

R^{1a}_{d}Si[(R^{2a})_{c}—CHR^{3a}CR^{4a}₂-]ₑ₁[(R^{2a})_{c}—C(R^{3a})(CHR^{4a}₂)-]ₑ₂

wherein each (R^{2a})_{c}—CHR^{3a}CR^{4a}₂— unit or (R^{2a})_{c}—C(R^{3a})(CHR^{4a}₂)— unit is bound directly to a silicon atom from a polysiloxane (e.g., (R^{2a})_{c}—CHR^{3a}CR^{4a}₂—(Si from polysiloxane)), wherein d+e=4, e is at least 2, e1+e2=e, R^{1a} is independently a monovalent organic group, R^{2a} is independently a divalent organic group or a siloxy group having the structure —O—Si(R^{1b})₂— wherein R^{1b} is independently C₁₋₁₀ alkyl, each of R^{3a} and R^{4a} is independently a monovalent organic group or H, and c is 0, 1, 2, 3, 4, 5, or 6. In some examples, the trialkylsilyl group can include a silicon-bound alkyl (e.g. ethyl) group, e.g. when R^{2a}=—O—Si(Me)₂— the trialkylsilyl group can include —Si(Me)₂CHR^{3a}CR^{4a}₂—Si, and the organic group can be considered to be —CR^{4a}₂CHR^{3a}—Si(Me)₂—O—SiR^{1a}_{d}-O—, such that the trialkylsilyl-substituted organic group bound to a polysiloxane A can be (Si from polysiloxane A)—CR^{4a}₂CHR^{3a}—Si(Me)₂—O—SiR^{1a}_{d}-O—Si(Me)₂CHR^{3a}CR^{4a}₂—(Si from another polysiloxane), wherein all variables are independently selected, wherein the Si bearing R^{1a}_{d} can have additional substituents, such as —(R^{2a})_{c}—CHR^{3a}CR^{4a}₂—. In some examples, R^{3a} and R^{4a} are hydrogen. In some examples each of R^{1a}, R^{2a}, R^{3a} or R^{4a} can independently be halogen substituted. In each —(R^{2a})_{c}—CHR^{3a}CR^{4a}₂— or (R^{2a})_{c}—C(R^{3a})(CHR^{4a}₂)— group, a single siloxane group can be present; thus, if c=1, R^{2a} can be a siloxy group, and if c is greater than 1, one of the independently selected multiple R^{2a} for the particular polysiloxane can be a siloxy group. See, for example, Examples 9 and 10.

The silicon-bonded trialkylsilyl-substituted organic groups are exemplified by, for example, trimethylsilylethyl, trimethylsilylpropyl, t-butyldimethylsilylethyl, diethylmethylsilylethyl, methylbistrimethylsiloxysilylethyl, tris(trimethylsiloxy)silylethyl, tris(trimethylsiloxy)silylpropyl, 3,3,3-trifluoropropyldimethylsilylethyl, dimethyltrifluoromethylsilylethyl, nonafluorohexyldimethylsilylethyl, and tris(trifluoropropyl)silylethyl.

### Method of Making an Organopolysiloxane Containing Silicon-Bonded Trialkylsilyl-Substituted Organic Groups

The present invention provides a method of making an organopolysiloxane that includes silicon-bonded trialkylsilyl-substituted organic groups. The method includes forming an organopolysiloxane mixture. The mixture includes an organohydrogenpolysiloxane having an average of at least two silicon-bonded hydrogen atoms per molecule. The mixture includes a hydrosilylation catalyst, which can be any suitable hydrosilylation catalyst. The mixture also includes an alkenyl-functional trialkylsilane. The method includes allowing the mixture to react (e.g. cure) to give an organopolysiloxane containing silicon-bonded trialkylsilyl-substituted organic groups.

The reaction is preferably a hydrosilylation reaction between at least some of the silicon-bonded hydrogen atoms of the organohydrogenpolysiloxane and the alkenyl groups of the alkenyl-functional trialkyl silane. Depending on the molar ratio of silicon-bonded hydrogen atoms to alkenyl-groups, the reaction can proceed, for example, until all silicon-bonded hydrogen atoms have reacted, until all alkenyl-groups have reacted, or until not necessarily equal amounts of silicon-bonded hydrogen atoms and alkenyl-groups remain unreacted. The extent of the hydrosilylation reaction can be controlled by, for example, controlling the molar ratio of silicon-bonded hydrogen atoms to alkenyl-groups, by controlling the amount of hydrosilylation catalyst relative to the amount of organohydrogenpolysiloxane and the amount of alkenyl-functional trialkylsilane, and by controlling the conditions of the reaction, such as concentration, and amount of radiation (heat, light, etc.). In some embodiments, the resulting organopolysiloxane containing silicon-bonded trialkylsilyl-substituted organic groups has undergone nearly complete or complete hydrosilylation. In other embodiments, the resulting organopolysiloxane containing silicon-bonded trialkylsilyl-substituted organic groups still has unreacted silicon-bonded hydrogen atoms. In some embodiments, the resulting organopolysiloxane can be included as at least one component of a membrane-forming composition. The remaining unreacted silicon-bonded hydrogen atoms can be present in an amount sufficient to allow the resulting organopolysiloxane containing silicon-bonded trialkylsilyl-substituted organic groups to participate in an additional hydrosilylation reaction in the same or different silicone composition.

The organohydrogenpolysiloxane can be present in about 1 wt % to 70 wt %, 2 wt % to 60 wt %, 3 wt % to 58 wt %, or about 5 wt % to 50 wt % of the reaction mixture. In some embodiments, the organohydrogenpolysiloxane can be present in about 1 wt % to 40 wt %, 5 wt % to 25 wt %, or about 7 wt % to 20 wt % of the reaction mixture. In some embodiments, the organohydrogenpolysiloxane can be present in about 10 wt % to 70 wt %, 15 wt % to 60 wt %, or about 20 wt % to 28 wt % organohydrogenpolysiloxane of the reaction mixture. In some embodiments, the organohydrogenpolysiloxane can be present in about 20 wt % to 70 wt %, 25 wt % to 65 wt %, or about 30 wt % to 40 wt % of the reaction mixture. In some embodiments, the organohydrogenpolysiloxane can be present in about 30 wt % to 70 wt %, 35 wt % to 65 wt %, or about 50 wt % to 60 wt %, of the reaction mixture. Wt % in this paragraph refers to the percent by weight based on the total weight of the hydrosilylation-reactive components of the reaction mixture. One of skill in the art will readily understood that the reaction mixture may include a solvent that is not hydrosilylation reactive. In some embodiments, the solvent is aprotic. In some embodiments, the solvent is essentially free of water and may be pre-dried with molecular sieves.

The hydrosilylation catalyst can be present in about 0.00001 wt % to 20 wt %, 0.001 wt % to 10 wt %, or about 0.01 wt % to 3 wt % of the reaction mixture. In some embodiments, the hydrosilylation catalyst can be present in about 0.001 wt % to 3 wt %, 0.01 wt % to 1 wt %, or about 0.1 wt % to 0.5 wt % of the reaction mixture. Wt % in the preceding lines of this paragraph refers to the percent by weight based on the total weight of the hydrosilylation-reactive components of the reaction mixture. In some embodiments, the reaction catalyst is chloroplatinic acid. In some embodiments, the reaction catalyst is Karstedt's catalyst. In some embodiments, the reaction catalyst is complexed or pre-dispersed in a solvent to form a complex or solution. In some embodiments, the catalyst complex or solution can be present in a concentration that provides about 1 to 10,000 parts per million (ppm), about 2 ppm to 5,000 ppm, or about 3 to 500 ppm, or about 5 to 300 ppm by weight of Pt relative to the hydrosilylation reactive components of the reaction mixture.

The alkenyl-functional trialkylsilane can be present in about 30 wt % to 99 wt %, 40 wt % to 98 wt %, 42 wt % to 97 wt %, or about 50 wt % to 95 wt % of the reaction mixture. In some embodiments, the alkenyl-functional trialkylsilane can be present in about 60 wt % to 99 wt %, 75 wt % to 95 wt %, or about 80 wt % to 95 wt % of the reaction mixture. In some embodiments, the alkenyl-functional trialkylsilane can be present in about 30 wt % to 90 wt %, 40 wt % to 85 wt %, or about 70 wt % to 80 wt % of the reaction mixture. In some embodiments, the alkenyl-functional trialkylsilane can be present in about 30 wt % to 80 wt %, 35 wt % to 75 wt %, or about 60 wt % to 70 wt % of the reaction mixture. In some embodiments, the alkenyl-functional trialkylsilane can be present in about 30 wt % to 70 wt %, 35 wt % to 65 wt %, 40 wt % to 60 wt %, or about 40 wt % to 50 wt % of the reaction mixture. Wt % in this paragraph refers to the percent by weight based on the total weight of the hydrosilylation-reactive components of the reaction mixture.

a. Organohydrogenpolysiloxane Having an Average of at Least Two Silicon-Bonded Hydrogen Atoms Per Molecule

In some examples, the organohydrogenpolysiloxane compound has an average of at least two, or more than two silicon-bonded hydrogen atoms. The organopolysiloxane compound can have a linear, branched, cyclic, or resinous structure. The organopolysiloxane compound can be a homopolymer or a copolymer. The organopolysiloxane compound can be a disiloxane, trisiloxane, or polysiloxane. The silicon-bonded hydrogen atoms in the organosilicon compound can be located at terminal, pendant, or at both terminal and pendant positions.

The organohydrogenpolysiloxane compound can be a single organohydrogenpolysiloxane or a combination including two or more organohydrogenpolysiloxanes that differ in at least one of the following properties: structure, viscosity, average molecular weight, siloxane units, and sequence.

In one example, an organohydrogenpolysiloxane can include a compound of the formula

R^{x}₃SiO(R^{x}₂SiO)_{α}(R^{x}R²SiO)_{β}SiR^{x}₃, or (c)

R⁴R^{x}₂SiO(R^{x}₂SiO)_{χ}(R^{x}R⁴SiO)_{δ}SiR^{x}₂R⁴. (d)

In formula (c), α has an average value of about 0 to about 500,000, and β has an average value of about 2 to about 500,000. Each R^{x} is independently halogen, hydrogen, or an organic group such as acrylate; alkyl; alkoxy; halogenated hydrocarbon; aryl; heteroaryl; and cyanoalkyl. Each R² is independently H or R^{x}. In some embodiments, β is less than about 20, is at least 20, 40, 150, or is greater than about 200.

In formula (d), χ has an average value of 0 to 500,000, and δ has an average value of 0 to 500,000. Each R^{x} is independently as described above. Each R⁴ is independently H or R^{x}. In some embodiments, δ is less than about 20, is at least 20, 40, 150, or is greater than about 200.

The organohydrogenpolysiloxane can have any suitable molecular weight. For example, the number-average molecular weight can be about 1,000-200,000 g/mol, 1,500-150,000, 2,400-100,000, 2,400-50,000, or about 1,000 to 40,000, or about 1,500, 2,000, 2,400, 3000, 3,500, 4,000, 4,500, or about 5,000 to about 40,000, 50,000, 75,000, 100,000, or to about 500,000 g/mol.

Examples of organohydrogenpolysiloxanes can include compounds having the average unit formula

(R^{x}R⁴R⁵SiO_{1/2})_{w}(R^{x}R⁴SiO_{2/2})ₓ(R⁴SiO_{3/2})_{y}(SiO_{4/2})_{z} (I),

wherein R^{x} is independently as defined herein, R⁴ is H or R^{x}, R⁵ is H or R^{x}, 0≦w<0.95, 0≦x<1, 0≦y<1, 0≦z<0.95, and w+x+y+z≈1. In some embodiments, R¹ is C₁₋₁₀ hydrocarbyl or C₁₋₁₀ halogen-substituted hydrocarbyl, both free of aliphatic unsaturation, or C₄ to C₁₄ aryl. In some embodiments, w is from 0.01 to 0.6, x is from 0 to 0.5, y is from 0 to 0.95, z is from 0 to 0.4, and w+x+y+z≈1.

b. Alkenyl-Functional Trialkylsilane

The uncured silicone composition of the present invention can include an alkenyl-functional trialkylsilane. The alkenyl-functional trialkyl silane can be any suitable alkenyl-functional trialkyl silane. The organic groups in the alkenyl-functional trialkylsilane can be halogen substituted to any extent, such as with fluorine atoms.

Examples of alkenyl-functional trialkylsilanes include compounds having the formula

R¹₃Si—(R²)_{c}—CR³═CR⁴₂,

wherein R¹ is independently a monovalent organic group such as C₁ to C₄ alkyl, R² is independently a divalent organic group or a siloxy group having the structure —O—Si(R^{1b})₂— wherein R^{1b} is independently C₁₋₁₀ alkyl or tri(C₁₋₁₀)alkylsiloxy, each of R³ and R⁴ is independently a monovalent organic group, and c is 0, 1, 2, 3, 4, 5, or 6. In some examples, R³ and R⁴ are hydrogen. In some examples R¹, R², R³ or R⁴ may be halogen substituted. In the linking-backbone of the linking group leading from the trialkylsilyl group to the alkene-group, a single siloxane group can be present; thus, if c=1, R² can be a siloxy group, and if c is greater than 1, one of the independently selected multiple R^{2a} can be a siloxy group. Therefore, in some embodiments, the alkenyl-functional trialkyl silane can be an alkenyl-functional trialkylsiloxy silane. In some embodiments, multiple siloxane groups can be excluded from the backbone of the linking group leading from the trialkylsilyl group to the alkenyl group. Multiple siloxy groups can occur in the linking group if they are appended to rather than part of the linking-backbone; thus, if R² is a siloxy group, R^{1b} can independently be a trimethylsiloxy group, for example. R^{1b} can independently include a single siloxy group; in various embodiments, multiple siloxane groups can independently be excluded from R^{1b}.

Other examples of alkenyl-functional trialkylsilanes include compounds having the formula

R¹_{d}Si[(R²)_{c}—CR³═CR⁴₂]ₑ,

wherein d+e=4, R¹ is independently a monovalent organic group, R² is independently a divalent organic group or a siloxy group having the structure —O—Si(R^{1b})₂— wherein R^{1b} is independently C₁₋₁₀ alkyl or tri(C₁₋₁₀)alkylsiloxy, each of R³ and R⁴ is independently a monovalent organic group or H, and c is 0, 1, 2, 3, 4, 5, or 6. In some examples, R³ and R⁴ are hydrogen. In some examples R¹, R², R³ or R⁴ can be halogen substituted. In the linking-backbone of the linking group leading from the trialkylsilyl group to each of the alkene-groups, a single siloxane group can be present; thus, if c=1, R² can be a siloxy group, and if c is greater than 1, one of the independently selected multiple R^{2a} for the particular alkenyl group can be a siloxy group. Therefore, in some embodiments, the alkenyl-functional trialkyl silane can be a bis- or tris(alkenyldialkylsiloxy)silane, such as for example tris(vinyldimethylsiloxy)methylsilane, or a di or trialkenylsilane such as for example trivinylmethylsilane. In some embodiments, multiple siloxane groups can be excluded from the backbone of the linking group leading from the trialkylsilyl group to each alkenyl group. Multiple siloxy groups can occur in the linking group if they are appended to rather than part of the linking-backbone; thus, if a particular R² is a siloxy group, R^{1b} for that particular alkenyl group can independently be a trimethylsiloxy group, for example. R^{1b} can independently include a single siloxy group; in various embodiments, multiple siloxane groups can independently be excluded from R^{1b}.

### II. Hydrosilylation-Curable Silicone Composition

The present invention provides a hydrosilylation-curable silicone composition, a cured product of the hydrosilylation-curable silicone composition, and a membrane that includes a cured product of the hydrosilylation-curable silicone composition. In an embodiment, the composition includes (A) an organohydrogenpolysiloxane having about 5 to about 99.99 mol % of the siloxane units bearing at least one trialkylsilyl substituted organic group and about 0.01 to about 30 mol % of the siloxane units bearing at least one silicon-bonded hydrogen atom, wherein the organopolysiloxane has a number-average molecular weight of at least about 2000 g/mol; (B) a compound having an average of at least two aliphatic unsaturated carbon-carbon bonds per molecule selected from (i) at least one organosilicon compound having an average of at least two silicon-bonded aliphatic unsaturated carbon-carbon bond-containing groups per molecule, (ii) at least one organic compound having at an average of at least two aliphatic unsaturated carbon-carbon bonds per molecule, and (iii) mixtures including (i) and (ii); and (C) a hydrosilylation catalyst.

In the hydrosilylation-curable silicone composition of the present invention, Component (A) can be present in about 40 wt % to 99 wt %, 50 wt % to 97 wt %, or about 60 wt % to 95 wt % of the uncured composition. In some embodiments, the Component (A) can be present in about 60 wt % to 80 wt %, 65 wt % to 75 wt %, or about 70 to 74% of the uncured composition. In some embodiments, Component (A) can be present in about 70 wt % to 95 wt %, 75 wt % to 90 wt %, or about 80 wt % to 85 wt % of the uncured composition. In some embodiments, Component (A) can be present in about 80 wt % to 99 wt %, 85 wt % to 95 wt %, or about 86 wt % to 93 wt % of the uncured composition. Wt % in this paragraph refers to the percent by weight based on the total weight of the hydrosilylation-reactive components of the uncured composition.

Component (B) can be present in about 1 wt % to 60 wt %, about 3 wt % to 50 wt %, or about 5 wt % to 40 wt % of the uncured composition. In some embodiments, Component (B) can be present in about 1 wt % to 20 wt %, 5 wt % to 15 wt %, or about 8 wt % to 15 wt % of the uncured composition. In some embodiments, Component (B) can be present in about 11 wt % to 40 wt %, 15 wt % to 35 wt %, or about 20 wt % to 30 wt % of the uncured composition. Wt % in this paragraph refers to the percent by weight based on the total weight of the hydrosilylation-reactive components of the uncured composition.

Component (C) can be present in about 0.00001 wt % to 20 wt %, 0.001 wt % to 10 wt %, or about 0.01 wt % to 3 wt % of the uncured composition. In some embodiments, the hydrosilylation catalyst can be present in about 0.001 wt % to 3 wt %, 0.01 wt % to about 1 wt %, or about 0.1 wt % to 0.3 wt % of the uncured composition. Wt % in this paragraph refers to the percent by weight based on the total weight of the hydrosilylation-reactive components of the uncured composition, including at least Components (A), (B), and (C).

Optionally, the hydrosilylation-curable silicone composition of the present invention can include any other components known in the art as additives for hydrosilylation curable compositions including solvents, fillers, reactive diluents and cure modifiers. In some cases the optional ingredients are hydrosilylation reactive, such as alkenyl functional additives.

### Component (A), Organohydrogenpolysiloxane

Component (A) can include any organohydrogenpolysiloxane described herein in the section Organopolysiloxane Containing at least One Silicon-Bonded Trialkylsilyl-Substituted Organic Group.

### Component (B), Compound Having an Average of at Least Two Aliphatic Unsaturated Carbon-Carbon Bonds Per Molecule.

The uncured silicone composition of the present invention can include Component (B), a compound having an average of at least two aliphatic unsaturated carbon-carbon bonds per molecule. Component (B) can be any suitable compound having an average of at least two aliphatic unsaturated carbon-carbon bonds per molecule. In one embodiment, Component (B) can include (i) at least one organosilicon compound having an average of at least two aliphatic unsaturated carbon-carbon bonds per molecule, (ii) at least one organic compound having an average of at least two aliphatic unsaturated carbon-carbon bonds per molecule, or (iii) a mixture including (i) and (ii).

Component (B) can be present in any suitable concentration. In some examples, there are about 0.5 moles of silicon-bonded hydrogen atoms per mole of aliphatic unsaturated carbon-carbon bonds in the silicone composition, or about 1, 1.5, 2, 3, 5, 10, 20, or more than about 20 moles of silicon-bonded hydrogen atoms, per mole of aliphatic unsaturated carbon-carbon bonds in the silicone composition. In some embodiments, the mole ratio of silicon-bonded hydrogen atoms in Component (A) is at about 0.001, 0.01, 0.1, 0.2, 0.3, 0.4, 0.5, 0.6, 0.7, 0.8, 0.9, 1, 5, 10, 15, 20, 30, 40, 50, 60, 70, 80, 90, 100, 150, about 200, or greater than about 200 per mole of aliphatic unsaturated carbon-carbon bonds in Component (B).

### Component (B), (i), Organosilicon Compound Having an Average of at Least Two Aliphatic Unsaturated Carbon-Carbon Bonds Per Molecule

The hydrosilylation-curable silicone composition of the present invention can include an organosilicon compound having an average of at least two aliphatic unsaturated carbon-carbon bonds per molecule. The organosilicon compound having an average of at least two aliphatic unsaturated carbon-carbon bonds per molecule can be any suitable organosilicon compound having an average of at least two unsaturated carbon-carbon bonds per molecule, wherein each of the two unsaturated carbon-carbon bonds is independently or together part of a silicon-bonded group. In some embodiments, the organosilicon compound having an average or at least two aliphatic unsaturated carbon-carbon bonds per molecule can be an organosilicon compound having an average of at least two silicon-bonded aliphatic unsaturated carbon-carbon bond-containing groups per molecule. In some embodiments, the organosilicon compound can have an average of least three aliphatic unsaturated carbon-carbon bonds per molecule. Component (B)(i) can be present in the uncured silicone composition in an amount sufficient to allow at least partial curing of the silicone composition.

The organosilicon compound can be an organosilane or an organosiloxane. The organosilane can have any suitable number of silane groups, and the organosiloxane can be a disiloxane, trisiloxane, or polysiloxane. The structure of the organosilicon compound can be linear, branched, cyclic, or resinous. Cyclosilanes and cyclosiloxanes can have from 3 to 12 silicon atoms, alternatively from 3 to 10 silicon atoms, alternatively from 3 to 5 silicon atoms. In acyclic polysilanes and polysiloxanes, the aliphatic unsaturated carbon-carbon bonds can be located at terminal, pendant, or at both terminal and pendant positions.

Examples of organosilanes suitable for use as component (B)(i) include, but are not limited to, silanes having the following formulae: Vi₄Si, PhSiVi₃, MeSiVi₃, PhMeSiVi₂, Ph₂SiVi₂, and PhSi(CH₂CH═CH₂)₃, where Me is methyl, Ph is phenyl, and Vi is vinyl.

Examples of aliphatic unsaturated carbon-carbon bond-containing groups can include alkenyl groups such as vinyl, allyl, butenyl, and hexenyl; alkynyl groups such as ethynyl, propynyl, and butynyl; or acrylate-functional groups such as acryloyloxyalkyl or methacryloyloxypropyl.

In some embodiments, Component (B), (i) is an organopolysiloxane of the formula

R^{y}₃SiO(R^{y}₂SiO)_{α}(R^{y}R²SiO)_{β}SiR^{y}₃,

R^{y}₂R⁴SiO(R^{y}₂SiO)_{χ}(R^{y}R⁴SiO)_{δ}SiR^{y}₂R⁴, (b)

or combinations thereof.

In formula (a), α has an average value of 0 to 2000, and β has an average value of 1 to 2000. Each R^{y} is independently halogen, hydrogen, or an organic group such as acrylate; alkyl; alkoxy; halogenated hydrocarbon; alkenyl; alkynyl; aryl; heteroaryl; and cyanoalkyl. Each R² is independently an unsaturated monovalent aliphatic carbon-carbon bond-containing group, as described herein.

In formula (b), χ has an average value of 0 to 2000, and δ has an average value of 1 to 2000. Each R^{y} is independently as defined above, and R⁴ is independently the same as defined for R² above.

Examples of organopolysiloxanes having an average of at least two aliphatic unsaturated carbon-carbon bonds per molecule include compounds having the average unit formula

(R¹R²R³SiO_{1/2})ₐ(R⁴R⁵SiO_{2/2})_{b}(R⁶SiO_{3/2})_{c}(SiO_{4/2})_{d} (I)

wherein each of R¹, R², R³, R⁴, R⁵, and R⁶ is an organic group independently selected from R^{y} as defined herein, 0≦a<0.95, 0≦b<1, 0≦c<1, 0≦d<0.95, a+b+c+d=1.

Component (B)(i) can be a single organosilicon compound or a mixture including two or more different organosilicon compounds, each as described herein. For example component (B)(i) can be a single organosilane, a mixture of two different organosilanes, a single organosiloxane, a mixture of two different organosiloxanes, or a mixture of an organosilane and an organosiloxane.

In some examples, Component (B)(i) can include a dimethylvinyl-terminated dimethyl siloxane, dimethylvinylated and trimethylated silica, tetramethyl tetravinyl cyclotetrasiloxane, dimethylvinylsiloxy-terminated polydimethylsiloxane, trimethylsiloxy-terminated polydimethylsiloxane-polymethylvinylsiloxane copolymer, dimethylvinylsiloxy-terminated polydimethylsiloxane-polymethylvinylsiloxane copolymer, or tetramethyldivinyldisiloxane. In some examples, the vinyl groups of the structures in the preceding list can be substituted with allyl, hexenyl, acrylic, methacrylic or other hydrosilylation-reactive unsaturated groups. In some examples, Component (B)(i) can include an organopolysiloxane resin consisting essentially of CH₂═CH(CH₃)₂SiO_{1/2} units, (CH₃)₃SiO_{1/2} units, and SiO_{4/2} units. In some examples, Component (B)(i) can include an oligomeric dimethylsiloxane(D)-methylvinylsiloxane(D^{Vi}) diol.

Component (B), (ii), Organic Compound Having an Average of at Least Two Aliphatic Unsaturated Carbon-Carbon Bonds Per Molecule

The hydrosilylation-curable silicone composition of the present invention can include an organic compound having an average of at least two aliphatic unsaturated carbon-carbon bonds per molecule. The aliphatic unsaturated carbon-carbon bonds can be alkenyl groups or alkynyl groups, for example.

Component (B)(ii) is at least one organic compound having an average of at least two aliphatic unsaturated carbon-carbon bonds per molecule. The organic compound can be any organic compound containing at least two aliphatic unsaturated carbon-carbon bonds per molecule, provided the compound does not prevent the organohydrogenpolysiloxane of the silicone composition from curing to form a cured product. The organic compound can be a diene, a triene, or a polyene. Also, the unsaturated compound can have a linear, branched, or cyclic structure. Further, in acyclic organic compounds, the unsaturated carbon-carbon bonds can be located at terminal, pendant, or at both terminal and pendant positions. Examples can include 1,4-butadiene, 1,6-hexadiene, 1,8-octadiene, and internally unsaturated variants thereof.

The organic compound can have a liquid or solid state at room temperature. Also, the organic compound is typically soluble in the silicone composition. The normal boiling point of the organic compound, which depends on the molecular weight, structure, and number and nature of functional groups in the compound, can vary over a wide range. In some embodiments, the organic compound has a normal boiling point greater than the cure temperature of the organohydrogenpolysiloxane, which can help prevent removal of appreciable amounts of the organic compound via volatilization during cure. The organic compound can have a molecular weight less than 500, alternatively less than 400, alternatively less than 300.

Component (B)(ii) can be a single organic compound or a mixture including two or more different organic compounds, each as described and exemplified herein. Moreover, methods of preparing unsaturated organic compounds are well-known in the art; many of these compounds are commercially available.

In one example, the organic compound having an average of at least two unsaturated carbon-carbon groups per molecule is a polyether having at least two aliphatic unsaturated carbon-carbon bonds per molecule. The polyether can be any polyalkylene oxide having at least two aliphatic unsaturated carbon-carbon bonds per molecule, or a halogen-substituted variant thereof.

### Component (C), Hydrosilylation Catalyst

The uncured silicone composition of the present invention can include a hydrosilylation catalyst. The hydrosilylation catalyst can be any suitable hydrosilylation catalyst. In some embodiments, the hydrosilylation catalyst can be any hydrosilylation catalyst including a platinum group metal or a compound containing a platinum group metal. Platinum group metals include platinum, rhodium, ruthenium, palladium, osmium and iridium. The platinum group metal can be platinum, based on its high activity in hydrosilylation reactions.

The silicone composition in its pre-cured state includes at least one hydrosilylation catalyst. During curing of the silicone composition, the hydrosilylation catalyst can catalyze an addition reaction (hydrosilylation) of components of the silicone composition, for example, between silicon-bonded hydrogen atoms and alkenyl or akynyl groups present in components of the composition. For example, the catalyst can catalyze a hydrosilylation reaction between silicon-bonded hydrogen atoms and alkenyl or alkynyl groups to give an organopolysiloxane. In some embodiments, the generated organpolysiloxane can have unreacted silicon-bonded hydrogen atoms such that, optionally, the organopolysiloxane can undergo additional curing, for example in the same or a different silicone composition. In other embodiments, the generated organopolysiloxane has no unreacted silicon-bonded hydrogen atoms.

### III. Membrane

In one embodiment, the present invention provides a membrane that includes a cured product of the silicone composition described herein. In another embodiment, the present invention provides a method of forming a membrane. The membrane of the present invention can have any suitable shape. In some examples, the membrane of the present invention is a plate-and-frame membrane, a spiral wound membrane, a tubular membrane, a capillary fiber membrane or a hollow fiber membrane. The membrane of the present invention can have any suitable thickness. In some examples, the membrane has a thickness of about 1 μm to 20 μm, 0.1 μm to 200 μm, or about 0.01 μm to 2000 μm. The membrane of the present invention can be selectively permeable to one substance over another. In one example, the membrane is selectively permeable to one gas over other gases or liquids. In another example, the membrane is selectively permeable to more than one gas over other gases or liquids. In one embodiment, the membrane is selectively permeable to one liquid over other liquids or gases. In another embodiment, the membrane is selectively permeable to more than one liquid over other liquids. In some examples, the membrane has an ideal CO₂/N₂ selectivity of at least about 5, 8, 9, or at least about 10. In some examples, the membrane has a CO₂/CH₄ selectivity of at least about 2, 2.5, 3, or at least about 4. In some embodiments, with a CO₂/N₂ mixture for example, the membrane has a CO₂ permeability coefficient of at least about 1000 Barrers, 1500, 2000, 2400, 2500, 2600, 3000, 3500, or at least about 4000 Barrers to about 10,000 Barrers, at about 21° C. In some embodiments, the membrane has a water vapor permeability coefficient of about 5,000 Barrers to 100,000 Barrers, or about 10,000, 15,000, 20,000, 30,000, or about 40,000 Barrers to 100,000 Barrers, at about 21° C.

### Supported Membrane

In some embodiments of the present invention, the membrane is supported on a porous or highly permeable non-porous substrate. The substrate can be any suitable substrate. A supported membrane has the majority of the surface area of at least one of the two major sides of the membrane contacting a porous or highly permeable non-porous substrate. A supported membrane on a porous substrate can be referred to as a composite membrane, where the membrane is a composite of the membrane and the porous substrate. The porous substrate on which the supported membrane is located can allow gases to pass through the pores and to reach the membrane. The supported membrane can be attached (e.g. adhered) to the porous substrate. The supported membrane can be in contact with the substrate without being adhered. The porous substrate can be partially integrated, fully integrated, or not integrated into the membrane.

### Unsupported Membrane

In some embodiments of the present invention, the membrane is unsupported, also referred to as free-standing. The majority of the surface area on each of the two major sides of a membrane that is free-standing is not contacting a substrate, whether the substrate is porous or not. In some embodiments, a membrane that is free-standing can be 100% unsupported. A membrane that is free-standing can be supported at the edges or at the minority (e.g. less than 50%) of the surface area on either or both major sides of the membrane. The support for a free-standing membrane can be a porous substrate or a nonporous substrate. A free-standing membrane can have any suitable shape, regardless of the percent of the free-standing membrane that is supported. Examples of suitable shapes for free-standing membranes include, for example, squares, rectangles, circles, tubes, cubes, spheres, cones, and planar sections thereof, with any thickness, including variable thicknesses.

In examples that include a substrate, the substrate can be porous or nonporous. The substrate can be any suitable material, and can be any suitable shape or size, including planar, curved, solid, hollow, or any combination thereof. The substrate can be a polymer. The substrate can be a water soluble polymer that is dissolved by purging with water. The substrate can be a fiber or hollow fiber, as described in U.S. Pat. No. 6,797,212 B2. In some examples, the substrate is coated with a material prior to formation of the membrane that facilitates the removal of the membrane once formed. The material that forms the substrate can be selected to minimize sticking between the membrane and the substrate. In some examples, the membrane can be heated, cooled, washed, etched or otherwise treated to facilitate removal from the substrate. In other examples, air pressure can be used to facilitate removal of the membrane from the substrate.

### Method of Separation

The present invention also provides a method of separating gas or vapor components in a feed gas mixture by use of the membrane described herein. The method includes contacting a first side of a membrane with a feed gas mixture to produce a permeate gas mixture on a second side of the membrane and a retentate gas mixture on the first side of the membrane. The permeate gas mixture is enriched in the first gas component. The retentate gas mixture is depleted in the first gas component. The membrane can include any suitable membrane as described herein.

The membrane can be free-standing or supported by a porous or permeable substrate. In some embodiments, the pressure on either side of the membrane can be about the same. In other embodiments, there can be a pressure differential between one side of the membrane and the other side of the membrane. For example, the pressure on the retentate side of the membrane can be higher than the pressure on the permeate side of the membrane. In other examples, the pressure on the permeate side of the membrane can be higher than the pressure on the retentate side of the membrane.

The feed gas mixture can include any mixture of gases or vapors. For example, the feed gas mixture can include air, hydrogen, carbon dioxide, nitrogen, ammonia, methane, water vapor, hydrogen sulfide, or any combination thereof. The feed gas can include any gas or vapor known to one of skill in the art. The membrane can be selectively permeable to any one gas in the feed gas, or to any of several gases in the feed gas. The membrane can be selectively permeable to all but any one gas in the feed gas.

Any number of membranes can be used to accomplish the separation. For example, one membrane can be used. The membranes can be manufactured as flat sheets or as fibers and can be packaged into any suitable variety of modules including hollow fibers, sheets or arrays of hollow fibers or sheets. Common module forms include hollow fiber modules, spiral wound modules, plate-and-frame modules, tubular modules and capillary fiber modules.

The present invention can be better understood by reference to the following examples which are offered by way of illustration. The present invention is not limited to the examples given herein.

### Reference Example 1

### Membrane Preparation

Prior to preparing membranes, the compositions described in the Examples and Comparative Examples were placed in a vacuum chamber under a pressure of less than 50 mm Hg for about 5 minutes at ambient laboratory temperature (about 21° C.) to remove any entrained air. Membranes were then prepared by drawing the composition described in the Examples into a uniform thin film with a doctor blade on a fluorosilicone-coated polyethylene terephthalate release film. The samples were then immediately placed into a forced air convection oven at a time and temperature sufficient to cure the films. For each composition, the curing schedule was determined by using differential scanning calorimetry to observe the temperatures at which the curing exotherms were observed. After curing, the membranes were then recovered by carefully peeling the cured compositions from the release film and transferred onto a fritted glass support for testing of permeation properties as described in Reference Example 2. The thickness of the samples was measured with a profilometer (Tencor P11 Surface Profiler).

### Reference Example 2

### Permeation Measurements

Gas permeability coefficients and ideal selectivities in a binary gas mixture were measured by a permeation cell including an upstream (feed) and a downstream (permeate) chamber that are separated by the membrane. Each chamber has one gas inlet and one gas outlet. The upstream chamber was maintained at 35 psi pressure and was constantly supplied with an equimolar mixture of CO₂ and N₂ at a flow rate of 200 standard cubic centimeters per minute (sccm). The membrane was supported on a glass fiber filter disk with a diameter of 83 mm and a maximum pore diameter range of 10-20 μm (Ace Glass). The membrane area was defined by a placing a butyl rubber gasket with a diameter of 50 mm (Exotic Automatic & Supply) on top of the membrane. The downstream chamber was maintained at 5 psi pressure and was constantly supplied with a pure He stream at a flow rate of 20 sccm. To analyze the permeability and separation factor of the membrane, the outlet of the downstream chamber was connected to a 6-port injector equipped with a 1-mL injection loop. On command, the 6-port injector injected a 1-mL sample into a gas chromatograph (GC) equipped with a thermal conductivity detector (TCD). The amount of gas permeated through the membrane was calculated by calibrating the response of the TCD detector to the gases of interest. The reported values of gas permeability and selectivity were obtained from measurements taken after the system had reached a steady state in which the permeate side gas composition became approximately invariant with time. All experiments were run at ambient laboratory temperature (21±about 2° C.).

Water Vapor Permeability Measurements.

Water vapor permeability coefficients were measured using the same permeation cell as described previously, with the same upstream and downstream chambers maintained at 35 psig and 5 psig, respectively, and with the same glass fiber filter disk support and butyl rubber gasket. A nitrogen supply of 140 sccm was provided, with 100 sccm of the nitrogen passing through a bubbler (Swagelok 500 mL steel cylinder containing water) to become saturated with water and 40 sccm of the nitrogen bypassing the bubbler and remaining dry. The wet and dry nitrogen streams then combined, and the relative humidity (RH) of the resultant feed stream was measured with a moisture transmitter (GE DewPro MMR31) and was determined to maintain a RH of about 69% under the experimental conditions. This stream was fed continuously into the upstream chamber of the permeation cell, and a helium sweep of 50 sccm was supplied continuously to the downstream chamber of the cell. The portion of the feed that permeated the membrane then combined with the helium sweep, and the resultant stream exited the downstream chamber. The RH of this stream was measured with a moisture transmitter (Omega HX86A) and the flow rate was measured with a soap bubble flow meter. The portion of the feed that did not permeate the membrane exited the upstream chamber as the retentate stream. The system was allowed to attain equilibrium, which was defined as the time at which the RH of both the feed stream and the stream exiting the downstream chamber remained constant. The water vapor permeability coefficient was calculated using the equation

$$\frac{\dot{Q}}{A} = \frac{P}{l} ( {[ RH * {p}_{sat} ]}_{feed} - {[ RH * {p}_{sat} ]}_{permeate} )$$

in which \dot{Q} is the volumetric flow rate of water vapor through the membrane, A is the area of the membrane, P is the permeability coefficient for water vapor, I is film thickness, and pₛₐₜ is saturation pressure. Nitrogen permeability was measured as described previously, in which the stream exiting the downstream chamber was analyzed by the GC. All experiments were run at ambient laboratory temperature.

### Reference Example 3

### Infrared Spectroscopy

Samples were tested at ambient laboratory conditions using a Nicolet 6700 FTIR equipped with a Smart Miracle attenuated total reflectance accessory having a zinc selenide crystal. Comparison of SiH signal heights among samples was done with identical baseline points and normalized by a suitable internal reference peak. Unreacted control samples were prepared and tested by blending the uncatalyzed reaction mixture in identical proportions to the final reactor contents for a given product.

### Reference Example 4

### Differential Scanning Calorimetry (DSC)

Samples were prepared by weighing less than 20 mg of sample into an aluminum DSC pan. The pan was hermetically sealed with a crimper then tested with a DSC (TA Instruments Q2000) ramped from −150° C. to 160° C. at a rate of 10° C./min.

### Reference Example 5

### Parallel Plate Rheology

Uncured samples were transferred from a sealed container to the gap between two 8 mm diameter parallel plates pre-heated at 70° C. in a TA Instruments ARES 4400 strain controlled rheometer and compressed to a final gap of 1.5 mm at room temperature. Excess sample was trimmed with a razor blade, then heated promptly in the environmental chamber to a temperature of 120° C. with the autotension feature activated to maintain a constant normal force during heating. The samples were allowed to complete in situ curing for 1 hour at 120° C. then cooled back to 25° C. under autotension. A frequency sweep was then conducted at 25° C. on the cured sample at a strain of 5% to determine its plateau dynamic storage modulus.

### Fractional Free Volume Calculations

Fractional free volume calculations fractional free volume (FFV) values were calculated a priori for a variety of siloxane-backbone polymers by using the formula FFV=(vₛₚ−vₒ)/vₛₚ (formula 1), wherein vₛₚ and vₒ are the specific volume and occupied volume, respectively, of a given polymer. This approach allows estimation of free volume based upon the chemical structure of the repeat unit of the polymer assuming a sufficiently high degree of polymerization that endgroup contributions are negligible. Values for vₛₚ and vₒ were obtained by known group contribution methods for which empirical parameters exist or can be readily estimated by comparison with experimental data from known compounds.

To predict vₛₚ, a group contribution method known as GCVOL by Elbro et al. was used (Elbro, H. S. et al. Ind. Eng. Chem. Res. 1991, 30 (12), 2576-2582). This method allows calculation of vₛₚ for a compound whose structure can be represented by a set of substituent structural-groups by summing over the specific volume contributions of each structural group, i, with the following formula vₛₚ=Σnᵢv_{sp,i} (formula 2), wherein nᵢ is the number of times group i appears in the nominal structure, and values of v_{sp,i} are determined from the following group contribution parameters, A, B, and C, using the following relationship: v_{sp,i}=Aᵢ+Bᵢ*T+Cᵢ*T² (formula 3) wherein T is the temperature of interest in Kelvin (in our case 298K), the index i refers to the specific structural group i, and values for A, B, and C are reported in the literature or may be determined empirically from fitting to experimentally determined bulk densities (the inverse of specific volume) of known compounds.

To predict vₒ, the group contribution method of Bondi method was used (Bondi, A. (1964). J. Phys. Chem. 68 (3): 441-51, and Van Krevelen, D. W.; Te Nijenhuls, K. Properties of Polymers; Elsevier: Amsterdam, 1990.), wherein the relationship vₒ=1.3*Σnᵢv_{w,i} (formula 4)

is used to sum over all groups, i, within the structure, wherein nᵢ is the number of times group i appears in the nominal structure and v_{w,i} is the van der Waals volume for group i. Tables of v_{w,i} can be found in the literature, such as the cited references by Bondi and Van Krevelen, for a large range of common groups.

Parameters for various structural groups used for calculation of vₛₚ and vₒ in the examples are shown in Tables 1 and 2, respectively, wherein AC indicates aromatic carbon. GCVOL parameters not appearing in the original publication were deduced by fitting to multiple standard compounds containing those groups whose densities are known or readily measured at 20° C.

TABLE 1
Group Contribution Parameters for Specific Volume

| | A | B*10³ | C*10⁵ |
|---|---|---|---|
| Group | cm³/mol | cm³/(mol K) | cm³/(mol K²) |
| SiO | 17.41 | −22.18 | 0 |
| Si | 86.71 | −555.5 | 97.9 |
| H (from SiH) | 13.75 | 0 | 0 |
| CH (cyclic) | −92.94 | 531.9 | −65.36 |
| CH₂ (cyclic) | 24.97 | −48.68 | 7.827 |
| ACH | 10.09 | 17.37 | 0 |
| ACSi (Si—Ph) | −2.76 | 0 | 0 |
| AC— (for Si—Ph) | −3.91 | 0 | 0 |
| CH₂ | 12.52 | 12.94 | 0 |
| >C═ | −0.3971 | −14.1 | 0 |
| ═CH— | 6.761 | 23.97 | 0 |
| ═CH₂ | 20.63 | 31.43 | 0 |
| OCH₃ | 16.66 | 74.31 | 0 |
| CH₃ | 18.96 | 45.58 | 0 |
| CH | 6.297 | −21.92 | 0 |
| —C | 1.296 | −59.66 | 0 |
| —CH₂—O— (aliph ether) | 14.41 | 28.54 | 0 |
| >CH—O— (ether) | 30.12 | −199.7 | 40.93 |
| COO (ester) | 14.23 | 11.93 | 0 |
| CH₃CO (ketone) | 42.18 | −67.17 | 22.58 |
| —CH₂Cl | 25.29 | 49.11 | 0 |
| —CF₂— | 24.52 | 0 | 0 |
| —CF₃ | 15.05 | 178.2 | −21.96 |

TABLE 2
Group Contribution Parameters for Van der Waals Volume

| | v_{W} | | v_{W} |
|---|---|---|---|
| Group | (cm³/mol) | Group | (cm³/mol) |
| SiO | 19.3 | >C═CH₂ | 16.95 |
| Si | 16.6 | >C═CH— | 13.5 |
| —Si(CH₃)₂— | 42.2 | OCH₃ | 17.37 |
| (bonded to C) | | | |
| —Si(CH₃)₃ | 55.87 | CH₃ | 13.67 |
| (bonded to C) | | | |
| H (from SiH) | 3.45 | CH | 6.78 |
| —CH (Cyclic) | 6.78 | —C | 3.33 |
| —CH₂ (Cyclic) | 10.23 | —CH₂—O— | 13.93 |
| | | (aliph ether) | |
| Cyclic decrement | −1.14 | >CH—O— (ether) | 10.48 |
| Phenyl- | 45.84 | COO (ester) | 15.2 |
| CH₂ | 10.23 | CH₃CO (ketone) | 25.37 |
| >C═C< | 10.02 | —CH₂Cl | 21.85 |
| ═CH— | 8.47 | —CF₂— | 14.8 |
| ═CH₂ | 11.94 | —CF₃ | 20.49 |

Generally, Table 2 values were used for calculations, with the exception of the values given for —Si(CH₃)₂— and —Si(CH₃)₃. The v_{w} value for Si(CH₃)₂ in Table 2 has been reported in the literature, and the v_{w} value for Si(CH₃)₃ can be derived from adding one CH₃ contribution to the value for Si(CH₃)₂. However, these values are inconsistent with Bondi's v_{w} values for Si and —CH₃, and these values because they yield a less conservative (lower) value of occupied volume, and consequently predict higher FFV, for a given structure than if the vw for the groups are derived from summing the Si and —CH₃ contributions individually. For example, in the calculations below, the effective contribution for v_{w,Si(CH3)3}=v_{w,Si}+3(v_{w,CH3})=16.6+3(13.67)=57.61

A sample calculation of FFV is illustrated for the control example of polydimethylsiloxane (Example C3), having repeating unit —[Si(CH₃)₂—O]ₙ—. First, the GCVOL method was used to calculate vₛₚ from Equations 2 and 3 and Table 1. For polydimethylsiloxane, the SiO group has A=17.41, B*10³=−22.18, and C*10⁵=0, n=1, nᵢv_{sp,i}=10.8; the CH₃ group has A=18.96, B*10³=45.58, and C*10⁵=0, n=2, nᵢv_{sp,i}=65.09 cm³/mol; therefore, vₛₚ=Σnᵢv_{sp,i}=75.89 cm³/mol=1.023 cm³/g, giving a predicted bulk density of 1/vₛₚ=0.977 g/cm³.

The repeat unit structure (nominal structure) can be broken down into the following groups shown in Table 1: SiO (1 group)+CH₃ (2 groups). The corresponding A, B, and C parameters for each group are used to calculate v_{sp,i}, which are then summed to give vₛₚ for the compound as follows (units omitted below):

v_{sp,SiO}=(17.41)+(−22.18*10⁻³)(298)+0(298)²=10.800 cm³/mol and n_{SiO}=1

v_{sp,CH3}=(18.96)+(45.58*10⁻³)(298)+0(298)²=32.543 cm³/mol and n_{CH3}=2

vₛₚ=Σnᵢv_{sp,i}=(1)(10.800)+(2)(32.543)=75.89 cm³/mol

This value can then be converted to a weight basis by dividing by the formula weight of the nominal structure (74.16 g/mol) to yield a specific volume of 1.02 cm³/g, or a density of 0.98 g/cm³. This calculated value of density compares very well with the experimentally reported density values of 0.97-0.98 g/cm³ in the range 293-298 K for moderate to high molecular weight PDMS (e.g. Dow Corning 200 Fluid, Information about Dow Corning Silicone Fluid, Dow Corning Corp. Form No. 22-931 A-90, 22-926D-93, 22-927B-90, 22-928E-94, 22-929A-90, 22-930A-90, and Bates, O.K., Ind. Eng. Chem. 41 (1949), 966.)

Next, the method of Bondi is used to calculate vₒ from equation 4 in an analogous fashion. For polydimethylsiloxane, the SiO group has v_{w}=19.3 and n=1, giving nᵢv_{w,i}=19.30 cm³/mol, the CH3 group has v_{w}=27.34 and n=2, giving nᵢv_{w,i}=27.34 cm³/mol; therefore, vₒ=Σnᵢv_{sp,i}=60.63 cm³/mol=0.818 cm³/g, giving a FFV=(vₛₚ−vₒ)=0.201 cm³/g.

A second sample FFV calculation is provided for the polymethyl, trimethylsilylethylsiloxane whose synthesis is described in Example 3. For polymethyl, trimethylsilylethylsiloxane, the SiO group has A=17.41, B*10³=−22.18, and C*10⁵=0, n=1, nᵢv_{sp,i}=10.80; the Si group has A=86.71, B*10³=−555.5, and C*10⁵=97.9, n=1, nᵢv_{sp,i}=8.11; the CH₂ group has A=12.52, B*10³=12.94, and C*10⁵=0, n=2, nᵢv_{sp,i}=32.75; and the CH₃ group has A=18.96, B*10³=45.58, and C*10⁵=0, n=4, nᵢv_{sp,i}=130.17; therefore, vₛₚ=>Σnᵢv_{sp,i}=181.83 cm³/mol=1.134 cm³/g, giving a predicted bulk density of 1/vₛₚ=0.882 g/cm³. Next, the SiO group has v_{w}=19.3 and n=1, giving nᵢv_{w,i}=19.30 cm³/mol; the Si group has v_{w}=16.6 and n=1, giving nᵢv_{w,i}=20.46 cm³/mol; the CH₂ group has v_{w}=10.23 and n=2, giving nᵢv_{w,i}=20.46 cm³/mol; the CH₃ group has v_{w}=13.67 and n=4, giving nᵢv_{w,i}=54.68 cm³/mol; therefore, vₒ=Σnᵢv_{sp,i}=144.35 cm³/mol=0.900 cm³/g, giving a FFV=(vₛₚ−vₒ)=0.206 cm³/g.

### Example 1

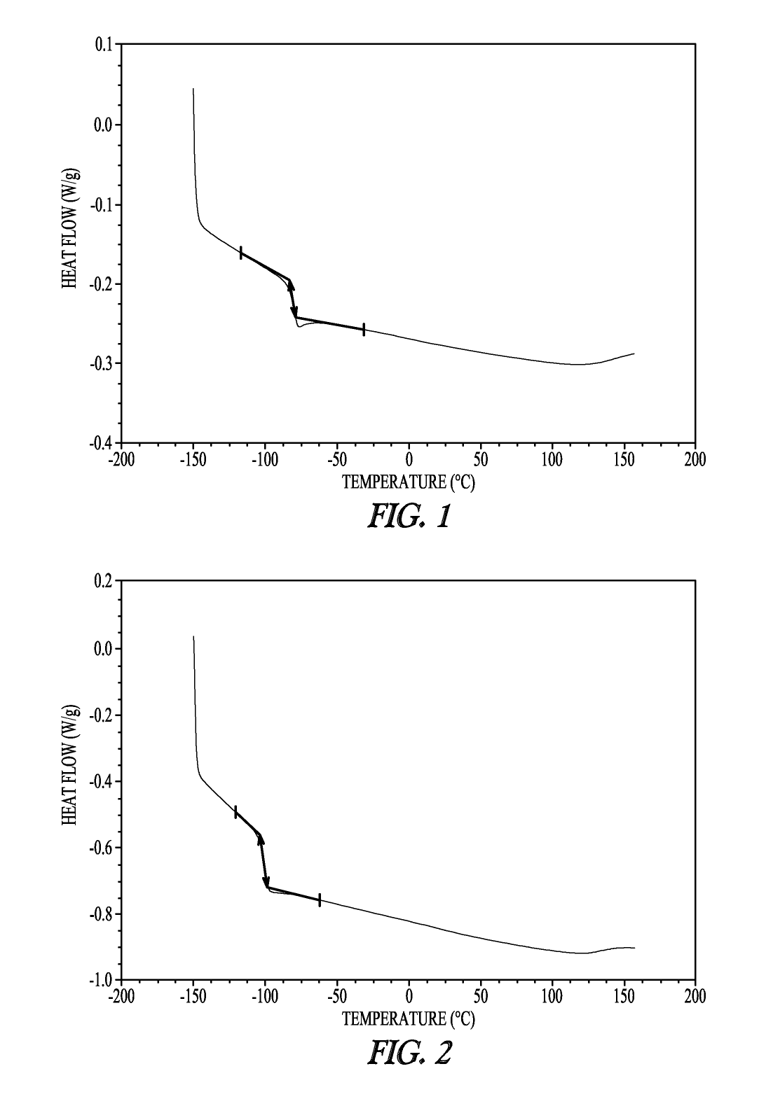

In a 250 ml 3-neck glass reactor, vinyltrimethylsilane (VTMS) (25.1 g) was added. The flask was fitted with a reflux condenser, a thermocouple probe with a temperature controller, and an addition funnel containing a trimethylsiloxy-terminated polydimethylsiloxane-polyhydridomethylsiloxane copolymer (PHMS-PDMS Copolymer 1) (24.0 g) having a viscosity of about 0.03 Pa·s at 25° C. and consisting of a molar ratio of hydridomethylsiloxane groups to dimethylsiloxane groups of about 2.4. The reactor was placed in an oil bath that was maintained at ambient laboratory temperature (20° C.). To the reactor was then added 0.16 g of a Karstedt's catalyst complex (adduct of 1,3-diethenyl-1,1,3,3-tetramethyldisiloxane and chloroplatinic acid, a platinum(IV) complex of 1,3-diethenyl-1,1,3,3-tetramethyldisiloxane) dilution in toluene containing 0.26% Pt (w/w) (Catalyst 1) and stirred magnetically. Dropwise addition of the PHMS-PDMS Copolymer 1 was then commenced, and the temperature was observed to increase gradually over the next hour to about 60° C., indicative of the desired exothermic hydrosilylation reaction. The reaction product was tested by attenuated total reflection infrared spectroscopy (ATR-IR) according to the method of Reference Example 2 and showed a large decrease in the SiH peak intensity at 2155 cm⁻¹ compared to an uncatalyzed cold mixture of the same concentration of reactants. The reaction product was further characterized by DSC according to the method of Reference Example 4 and exhibited a glass transition temperature of −79° C. with no observable melting endotherm, no cold crystallization peak and no residual exotherm, see FIG. 1.

### Example 2

In a 250 ml 3-neck glass reactor, 25.9 g of allyltrimethylsilane (ATMS) was added. The flask was fitted with a reflux condenser, a thermocouple probe with a temperature controller, and an addition funnel containing 14.2 g of a trimethylsiloxy-terminated polyhydridomethylsiloxane copolymer (PHMS 1) having a viscosity of about 0.30 Pa·s at 25° C. The reactor was placed in an oil bath that was maintained at ambient laboratory temperature (20° C.). To the reactor was then added 0.12 g of Catalyst 1 and stirred magnetically. About 5 ml of the PHMS 1 was added to the reactor dropwise, and the temperature was gradually raised to a setpoint of 65° C. After equilibrating at 63° C., dropwise addition of PHMS 1 was resumed. The temperature was observed to rise significantly over the next 13 minutes, indicative of the desired exothermic hydrosilylation reaction. The reaction product was tested by ATR-IR according to the method of Reference Example 2 and showed a large decrease in the SiH peak intensity at 2155 cm⁻¹ compared to an uncatalyzed cold mixture of the same concentration of reactants. The reaction was driven to completion by heating the product further in a DSC pan to 160° C., showing a small exotherm indicative of the reaction of residual reactants. The reaction product was then characterized by DSC according to the method of Reference Example 4 and exhibited a glass transition temperature of −101° C. with no observable melting endotherm, no cold crystallization peak and no residual exotherm, see FIG. 2.

### Comparative Example C1

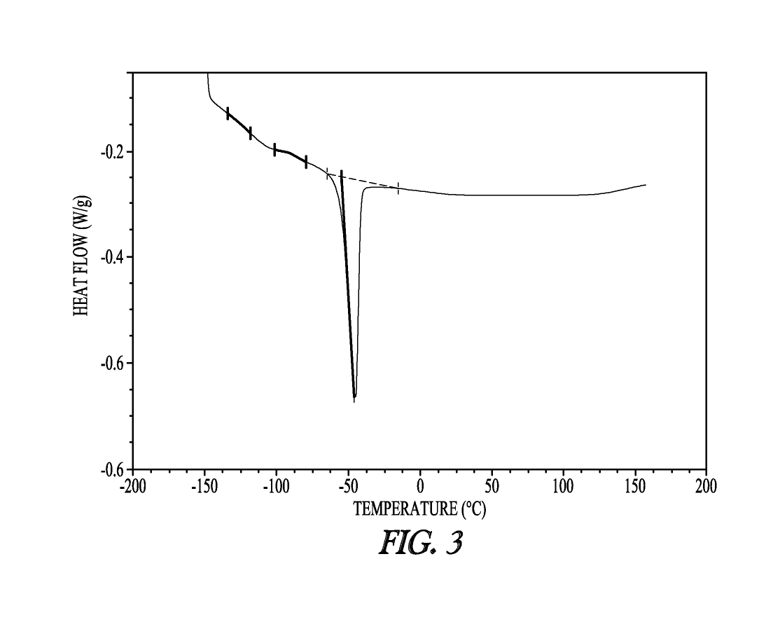

Dimethylvinylsiloxy-terminated polydimethylsiloxane having a viscosity of about 55 Pa·s at 25° C. (PDMS-1) was tested according to the method of Reference Example 4 and found to show a glass transition temperature of −125° C. and also showed a large endothermic melting peak at −46° C. preceded by a cold crystallization exothermic peak at −81° C., see FIG. 3.

### Comparative Example C2

PHMS 1 was tested according to the method of Reference Example 4 and found to show a glass transition temperature of −137° C. and no observable melting endotherm or cold crystallization peak.

Examples 1 and 2 taken in comparison with Comparative Examples C1 and C2 demonstrate that embodiments of the polymers provided by the present invention can be rubbery polymers with significantly different thermal properties from either conventional PDMS or the PHMS1 constituent polymer. Unlike PDMS, they show no evidence of crystallinity and therefore can offer unique thermomechanical properties.

The following examples are based upon a reaction of a polyhydridosiloxane with an unsaturated compound using a procedure similar to what is described in Examples 1-2. In all cases, the stoichiometry is controlled to give an essentially complete reaction of SiH resulting in structures for which the fractional free volumes are calculated by the method of Reference Example 6 and reported in Table 4. Unless otherwise noted, the reactions described below are conducted with a slight molar excess, such as 5-10 mol %, of the alkenyl groups from the alkenyl functional trialkylsilane relative to the SiH groups from the organohydrogenpolysiloxane. It is understood that an inert mutual solvent is used in the general procedure described in Example 1 as needed in the cases described below to control exothermic heating and maintain miscibility of the reactants during the reaction.

Examples 3-22 are theoretical examples, in which the procedure of Example 1 is followed using the materials indicated in Table 3 to generate the hydrosilylation product. In example 6, the molar ratio of vinyl groups from the tris(vinyldimethylsiloxy)methylsilane to the SiH groups from the trimethylsiloxy-terminated polyhydridomethylsiloxane is 3. In Example 7, the molar ratio of vinyl groups from the trivinylmethylsilane to the SiH groups from the trimethylsiloxy-terminated polyhydridomethylsiloxane is 3. In Example 17, the reaction is carried out in a pressure-rated Parr reactor with cooling coils using 0.17 ml chloroplatinic acid solution (0.1 M in 2-propanol) as the catalyst instead of Catalyst 1 and heating the reactor to 100° C. and allowing the mixture to react for 16 hours.

TABLE 3
Theoretical Examples 3-21.

| Exam- | |
|---|---|
| ple | Reagents |
| 3 | PHMS 1 (10.0 g) and vinyltrimethylsilane (18.2 g) |
| 4 | PHMS 1 (10.0 g) and allyltrimethylsilane (20.7 g) |
| 5 | PHMS 1 (10.0 g) and allyltrimethylsilane (54.7 g) |
| 6 | PHMS 1 (10.0 g) and tris(vinyldimethylsiloxy)methylsilane |
| | (56.5 g) |
| 7 | PHMS 1 (10.0 g) and trivinylmethylsilane (20.0 g) |
| 8 | PHMS 1 (10.0 g) and vinyl-t-butyldimethylsilane (25.8 g) |
| 9 | PHMS 1 (10.0 g) and vinyldiethylmethylsilane (23.2 g) |
| 10 | PHMS 1 (10.0 g) and vinylmethylbis(trimethylsiloxy)silane |
| | (45.0 g) |
| 11 | PHMS 1 (10.0 g) and vinyltris(trimethylsiloxy)silane (58.4 g) |
| 12 | PHMS 1 (10.0 g) and vinyl(3,3,3-trifluoropropyl)dimethylsilane |
| | (33.0 g) |
| 13 | PHMS 1 (10.0 g) and vinyl(trifluoromethyl)dimethylsilane |
| | (27.9 g) |
| 14 | PHMS 1 (10.0 g) and vinylpentamethyldisiloxane (31.6 g) |
| 15 | PHMS 1 (10.0 g) and vinylnonafluorohexyldimethylsilane |
| | (60.2 g) |
| 16 | PHMS 1 (10.0 g) and tris(trifluoropropyl)vinylsilane (62.7 g) |
| 17 | PHMS 1 (10.0 g) and 3,3,3-trifluoroprop-1-ene (17.4 g) |
| 18 | PHMS 1 (10.0 g) and perfluorohexylethylene |
| | (CH₂═CH—(CF₂)₆F) (62.7 g) |
| 19 | PHMS 1 (10.0 g) and 9,9,9,8,8,7,7,6,6-nonafluorohex-1-ene |
| | (CH₂═CH—(CF₂)₄F) (44.6 g) |
| 20 | PHMS 1 (5.0 g) and 9,9,9,8,8,7,7,6,6-nonafluorohex-1-ene |
| | (CH₂═CH—(CF₂)₄F) (58.9 g) |
| 21 | PHMS 1 (10.0 g) and an equimolar mixture of 9,9,9,8,8,7,7,6,6- |
| | nonafluorohex-1-ene (CH₂═CH—(CF₂)₄F) (58.9 g) |

TABLE 4
Fractional free volumes (FFV) for various Examples,
as determined by the method of Bondi.

| | | Density | |
|---|---|---|---|
| Exam- | | @ 25° | |
| ple | Description of Reaction Product | (g/cc) | FFV |
| C3 | Polydimethylsiloxane | 0.977 | 0.201 |
| C4 | Polymethylphenylsiloxane | 1.177 | 0.115 |
| C5 | Polydiethylsiloxane | 0.941 | 0.197 |
| 3 | Polymethyl, trimethylsilylethylsiloxane | 0.882 | 0.206 |
| 4 | Polymethyl, trimethylsilylpropylsiloxane | 0.880 | 0.205 |
| 5 | Polydi(trimethylsilylpropyl)siloxane | 0.857 | 0.205 |
| 6 | Polymethyl, methylsiloxybis(vinyldimeth- | 0.941 | 0.205 |
| | ylsiloxy)methylsilylethylsiloxane | | |
| 7 | Polymethyl, divinylmethylsilylethylsiloxane | 0.901 | 0.209 |
| 8 | Polymethyl, t-butyldimethylsilylethylsiloxane | 0.879 | 0.210 |
| 9 | Polymethyl, diethylmethylsilylethylsiloxane | 0.878 | 0.203 |
| 10 | Polymethyl, methylbistrimethylsiloxysilyleth- | 0.925 | 0.204 |
| | ylsiloxane | | |
| 11 | Polymethyl, tris(trimethylsiloxy)silylethylsi- | 0.935 | 0.203 |
| | loxane | | |
| 12 | Polymethyl, 3,3,3-trifluoropropyl, dimethyl- | 1.051 | 0.230 |
| | silylethylsiloxane | | |
| 13 | Polymethyl, dimethyltrifluoromethylsilyleth- | 1.083 | 0.237 |
| | ylsiloxane | | |
| 14 | Polymethyl, (trimethylsiloxanyl, dimeth- | 0.910 | 0.205 |
| | yl)silylethylsiloxane | | |
| 15 | Polymethyl, nonafluorohexyldimethylsilyleth- | 1.290 | 0.227 |
| | ylsiloxane | | |
| 16 | Polymethyl, tris(trifluoropropyl)silylethylsi- | 1.238 | 0.237 |
| | loxane | | |
| 17 | Polymethyl, 3,3,3-trifluoropropylsiloxane | 1.252 | 0.230 |
| 18 | Polymethyl, perfluorohexylethylsiloxane | 1.642 | 0.223 |
| 19 | Polymethyl, 9,9,9,8,8,7,7,6,6-nonafluorohexyl- | 1.544 | 0.224 |
| | siloxane | | |
| 20 | Polydi(9,9,9,8,8,7,7,6,6-nonafluorohexyl)si- | 1.678 | 0.230 |
| | loxane | | |
| 21 | Polysiloxane with 9,9,9,8,8,7,7,6,6-nonafluoro- | 1.290 | 0.219 |
| | hexyl and trimethylsilylethyl substitutents | | |
| 22 | Polymethyl, tris(trimethylsiloxy)silylpropylsi- | 0.931 | 0.203 |
| | loxane | | |

The following Examples are based upon partial reaction of a polyhydridosiloxane with an unsaturated compound to form an organohydrogenpolysiloxane having a plurality of trialkyl substituted organic groups using a procedure similar to what is described in Example 1. In these Examples, the stoichiometry is controlled to leave an average of at least two Si—H groups per molecule for subsequent crosslinking. Unless otherwise, noted the reactions described below are conducted with a slight molar deficit, such as 1-20 mol % fewer alkenyl groups from the alkenyl functional trialkylsilane relative to the SiH groups from the organohydrogenpolysiloxane. It is understood that in the Examples below an inert solvent is used in the general procedure described in Example 1 as needed to control exothermic heating and maintain miscibility of the reactants during the reaction.

Table 5 shows theoretical Examples 23-44, in which the procedure of Example 1 is followed using the materials indicated in Table 5. In Example 35, the 3,3,3-trifluoroprop-1-ene (14.2 g) which is first passed through a dessicant column (Ascarite), and the reaction is carried out in a pressure-rated Parr reactor with cooling coils using 0.17 ml chloroplatinic acid solution (0.1 M in 2-propanol) as the catalyst instead of Catalyst 1 and heating the reactor to 100° C. and allowing the mixture to react for 16 hours to yield the hydrosilylation product.

TABLE 5
Theoretical Examples 23-44.

| Exam- | |
|---|---|
| ple | Reagents |
| 23 | PHMS 1 (10.0 g) and vinyltrimethylsilane (16.0 g) |
| 24 | PHMS 1 (10.0 g) and allyltrimethylsilane (16.9 g) |
| 25 | PHMS 1 (10.0 g) and allyltrimethylsilane (44.8 g) |
| 26 | PHMS 1 (10.0 g) and vinyl-t-butyldimethylsilane (21.1 g) |
| 27 | PHMS 1 (10.0 g) and vinyldiethylmethylsilane (19.0 g) |
| 28 | PHMS 1 (10.0 g) and vinylmethylbis(trimethylsiloxy)silane |
| | (36.8 g) |
| 29 | PHMS 1 (10.0 g) and vinyltris(trimethylsiloxy)silane (47.8 g) |
| 30 | PHMS 1 (10 g) and vinyl(3,3,3-trifluoropropyl)dimethylsilane |
| | (27.0 g) |
| 31 | PHMS 1 (10.0 g) and vinyl(trifluoromethyl)dimethylsilane |
| | (22.9 g) |
| 32 | PHMS 1 (10.0 g) and vinylpentamethyldisiloxane (25.8 g) |
| 33 | PHMS 1 (10.0 g) and vinylnonafluorohexyldimethylsilane |
| | (49.2 g) |
| 34 | PHMS 1 (10.0 g) and tris(trifluoropropyl)vinylsilane (51.3 g) |
| 35 | PHMS 1 (10.0 g) and 3,3,3-trifluoroprop-1-ene (14.2 g) |
| 36 | PHMS 1 (10.0 g) and perfluorohexylethylene |
| | (CH₂═CH—(CF₂)₆F) (51.3 g) |
| 37 | PHMS 1 (10.0 g) and 9,9,9,8,8,7,7,6,6-nonafluorohex-1-ene |
| | (CH₂═CH—(CF₂)₄F) (36.5 g) |
| 38 | PHMS 1 (5.0 g) and 9,9,9,8,8,7,7,6,6-nonafluorohex-1-ene |
| | (CH₂═CH—(CF₂)₄F) (48.2 g) |
| 39 | PHMS 1 (10.0 g) and an equimolar mixture of 9,9,9,8,8,7,7,6,6- |
| | nonafluorohex-1-ene (CH₂═CH—(CF₂)₄F) (48.2 g) |
| 40 | PHMS 1 (10.0 g) and allyltris(trimethylsiloxy)silane (49.9 g) |
| 41 | trimethylsiloxy-terminated polyhydridomethylsiloxane having |
| | a number average molecular weight of approximately 30,000 |
| | g/mol (PHMS 2) (10.0 g) and allyltris(trimethylsiloxy)silane |
| | (55.7 g) |
| 42 | trimethylsiloxy-terminated polyhydridomethylsiloxane having |
| | a number average molecular weight of approximately 30,000 |
| | g/mol (PHMS 2) (10.0 g) and vinyltrimethylsilane (16.6 g) |
| 43 | trimethylsiloxy-terminated polydimethylsiloxane- |
| | polyhydridomethylsiloxane copolymer (PHMS-PDMS |
| | Copolymer 2) having a number average molecular weight |
| | of approximately 27,000 g/mol and a molar ratio of |
| | hydridomethylsiloxane groups to dimethylsiloxane |
| | groups of about 1.5 (10.0 g) and vinyltrimethylsilane (8.4 g) |
| 44 | PHMS-PDMS Copolymer 2 (10.0 g) and |
| | allyltris(trimethylsiloxy)silane (28.2 g) |

### Example 45

### Theoretical

Part A of a 2 part siloxane composition is prepared by combining 99.8 parts of a vinyldimethylsiloxy terminated poly(dimethylsiloxane-methylvinylsiloxane) random copolymer having a viscosity of about 0.45 Pa-s at 25° C. and an average of about 2.5 mol % of methylvinylsiloxane units relative to the combined number of dimethylsiloxane and methylvinylsiloxane repeating units in the polymer backbone (Vi-PDMS 2) and 0.2 parts of Karstedt's Catalyst dispersion having a platinum concentration of 24% Pt (w/w) (Catalyst 2). Part B of a 2 part siloxane composition is prepared by combining 93.7 parts of the polymer of Example 23, 6.25 parts of Vi-PDMS 2 and 0.01 parts of 2-methyl-3-butyn-2-ol. 10 parts Part B is combined with 1 part of Part A and mixed with a Hauschild rotary mixer for two 20 s cycles with a manual spatula mixing step in between cycles. The composition is drawn into a film and cured for 60 min at 130° C. to yield a membrane.

### Example 46

### Theoretical

Part A of a 2 part siloxane composition is prepared by combining 99.9 parts of Vi-PDMS 2 and 0.1 parts of Catalyst 2. Part B of a 2 part siloxane composition is prepared by combining 87.8 parts of the polymer of Example 40, 12.2 parts of Vi-PDMS 2 and 0.01 parts of 2-methyl-3-butyn-2-ol. 5 parts Part B is combined with 1 part of Part A and mixed with a Hauschild rotary mixer for two 20 s cycles with a manual spatula mixing step in between cycles. The composition is drawn into a film and cured for 60 min at 130° C. to yield a membrane.

### Example 47

### Theoretical

Part A of a 2 part siloxane composition is prepared by combining 90.0 parts of Vi-PDMS 2, 10.3 parts of a vinyldimethylsiloxy terminated polydimethylsiloxane (Vi-PDMS 3) having a viscosity of about 0.03 Pa-s at 25° C. and 0.2 parts of Catalyst 2. Part B of a 2 part siloxane composition is prepared by combining 99.2 parts of the polymer of Example 41, 0.1 parts of a trimethylsiloxy-terminated polydimethylsiloxane-polyhydridomethylsiloxane copolymer (PHMS-PDMS Copolymer 3) having a viscosity of about 0.005 Pa·s at 25° C. and consisting of a molar ratio of hydridomethylsiloxane groups to dimethylsiloxane groups of about 1.7, 0.7 parts of Vi-PDMS 3 and 0.01 parts of 2-methyl-3-butyn-2-ol. 10 parts Part B is combined with 1 part of Part A and mixed with a Hauschild rotary mixer for two 20 s cycles with a manual spatula mixing step in between cycles. The composition is drawn into a film and cured for 60 min at 130° C. to yield a membrane.

### Example 48

### Theoretical

Part B of a 2 part siloxane composition is prepared by combining 96.6 parts of the polymer of Example 42, 0.4 parts of PHMS-PDMS Copolymer 3, 3.0 parts of Vi-PDMS 3 and 0.006 parts of 2-methyl-3-butyn-2-ol. 10 parts Part B is combined with 1 part of Part A of Example 45 and mixed with a Hauschild rotary mixer for two 20 s cycles with a manual spatula mixing step in between cycles. The composition is drawn into a film and cured for 60 min at 130° C. to yield a membrane.

### Example 49

### Theoretical

Part A of a 2 part siloxane composition is prepared by combining a mixture including 68.24 parts Vi-PDMS 1 and 31.6 parts of organopolysiloxane resin consisting essentially of CH₂═CH(CH₃)₂SiO_{1/2} units, (CH₃)₃SiO_{1/2} units, and SiO_{4/2} units, wherein the mole ratio of CH₂═CH(CH₃)₂SiO_{1/2} units and (CH₃)₃SiO_{1/2} units combined to SiO_{4/2} units is about 0.7, and the resin has weight-average molecular weight of about 22,000, a polydispersity of about 5 and contains about 1.8% by weight (about 5.5 mole %) of vinyl groups (Vi-Resin), and 0.2 parts Catalyst 2. Part B of a 2 part siloxane composition is prepared by combining a mixture including 91.2 parts of the polymer of Example 42, 5.8 parts Vi-PDMS 1, and 2.7 parts Vi-Resin, 0.4 parts of PHMS-PDMS Copolymer 3 and 0.006 parts of 2-methyl-3-butyn-2-ol. 10 parts Part B is combined with 1 part of Part A and mixed with a Hauschild rotary mixer for two 20 s cycles with a manual spatula mixing step in between cycles. The composition is drawn into a film, and cured for 60 min at 130° C. to yield a membrane.

### Example 50

### Theoretical

Part B of a 2 part siloxane composition is prepared by combining a mixture including 78.0 parts of the polymer of Example 43, 13.1 parts Vi-PDMS 1, 6.0 parts Vi-Resin, 1 parts of a trimethylsiloxy-terminated polydimethylsiloxane-polyhydridomethylsiloxane copolymer (PHMS-PDMS Copolymer 4) having a viscosity of about 0.3 Pa·s at 25° C. and consisting of a molar ratio of hydridomethylsiloxane groups to dimethylsiloxane groups of about 0.14, 2 parts of 1-tetradecene, and 0.006 parts of 2-methyl-3-butyn-2-ol. 10 parts Part B is combined with 1 part of Part A of Example 49 and mixed with a Hauschild rotary mixer for two 20 s cycles with a manual spatula mixing step in between cycles. The composition is drawn into a film, and cured for 60 min at 130° C. to yield a membrane.

### Example 51

### Theoretical

Part B of a 2 part siloxane composition is prepared by combining a mixture including 78.8 parts of the polymer of Example 44, 13.1 parts Vi-PDMS 1, 6.1 parts Vi-Resin, 1 part of PHMS-PDMS Copolymer 4, 1 part of 1-tetradecene, and 0.006 parts of 2-methyl-3-butyn-2-ol. 10 parts Part B is combined with 1 part of Part A of Example 49 and mixed with a Hauschild rotary mixer for two 20 s cycles with a manual spatula mixing step in between cycles. The composition is drawn into a film, and cured for 60 min at 130° C. to yield a membrane.

The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

1. An organopolysiloxane comprising siloxane units, wherein about 5 to about 100 mol % of the siloxane units are bound to at least one trialkylsilyl-substituted organic group, wherein the organopolysiloxane has a number-average molecular weight of about 2,000 to about 2,000,000 g/mol.

2. The organopolysiloxane of claim 1, wherein the trialkylsilyl-substituted organic group has the formula
R¹₃Si—(R²)_{c}—CHR³CR⁴₂—,
wherein R¹ is C₁ to C₄ alkyl, R² is a divalent organic group or a siloxy group having the structure —O—Si(R^{1b})₂— wherein R^{1b} is independently C₁₋₁₀ alkyl or tri(C₁₋₁₀)alkylsiloxy, each of R³ and R⁴ is independently C₁₋₁₀ hydrocarbyl or H, and c is 0 or 1.

3. The organopolysiloxane of claim 1, wherein the trialkyl-substituted organic group has the formula
R^{1a}_{d}Si[(R^{2a})_{c}—CHR^{3a}CR^{4a}₂-]ₑ,
R^{1a}_{d}Si[(R^{2a})_{c}—C(R^{3a})(CHR^{4a}₂)-]ₑ, or
R^{1a}_{d}Si[(R^{2a})_{c}—CHR^{3a}CR^{4a}₂-]ₑ₁[(R^{2a})_{c}—C(R^{3a})(CHR^{4a}₂)-]ₑ₂
wherein d+e=4, e is at least 2, e1+e2=e, each R^{1a} is independently a monovalent organic group, each R^{2a} is independently a divalent organic group or a siloxy group having the structure —O—Si(R^{1b})₂— wherein each R^{1b} is independently C₁₋₁₀ alkyl, each of R^{3a} and R^{4a} is independently a monovalent organic group or H, and c is 0 or 1.

4. The organopolysiloxane of claim 1, wherein the trialkylsilyl-substituted organic groups are selected from the group consisting of trimethylsilylethyl, trimethylsilylpropyl, t-butyldimethylsilylethyl, diethylmethylsilylethyl, methylbistrimethylsiloxysilylethyl, tris(trimethylsiloxy)silylethyl, tris(trimethylsiloxy)silylpropyl, 3,3,3-trifluoropropyldimethylsilylethyl, dimethyltrifluoromethylsilylethyl, nonafluorohexyldimethylsilylethyl, tris(trifluoropropyl)silylethyl, and combinations thereof.

5. The organopolysiloxane of claim 1, wherein the organopolysiloxane is an organohydrogenpolysiloxane, wherein about 0.01 to about 30 mol % of the siloxane units have at least one silicon-bonded hydrogen atom.

6. A hydrosilylation-curable silicone composition, comprising the organopolysiloxane of claim 1.

7. A membrane comprising a reaction product of the organopolysiloxane of claim 1.

8. A method of making the organopolysiloxane of claim 1, comprising:
forming an organopolysiloxane mixture, comprising
an organohydrogenpolysiloxane having an average of at least two silicon-bonded hydrogen atoms per molecule;
a hydrosilylation catalyst; and
an alkenyl-functional trialkylsilane; and
allowing the mixture to react to give the organopolysiloxane of claim 1.

9. A hydro silylation-curable silicone composition comprising:
(A) an organohydrogenpolysiloxane comprising siloxane units, wherein about 5 to about 99.99 mol % of the siloxane units are bound to at least one trialkylsilyl-substituted organic group and about 0.01 to about 30 mol % of the siloxane units are bound to at least one hydrogen atom, wherein the organohydrogenpolysiloxane has a number-average molecular weight of about 2,000 to about 100,000 g/mol;
(B) a compound having an average of at least two aliphatic unsaturated carbon-carbon bonds per molecule selected from
(i) at least one organo silicon compound having an average of at least two aliphatic unsaturated carbon-carbon bonds per molecule,
(ii) at least one organic compound having at an average of at least two aliphatic unsaturated carbon-carbon bonds per molecule, and
(iii) mixtures comprising (i) and (ii); and
(C) a hydrosilylation catalyst;
wherein the ratio of the moles of silicon-bonded hydrogen atoms in Component (A) to the sum of the number of moles of aliphatic unsaturated carbon-carbon bonds in the composition is about 0.1 to about 20.

10. A cured product of the silicone composition of claim 9.

11. An unsupported membrane comprising the cured product of claim 10, wherein the membrane is free-standing and the membrane has a water vapor permeability of about 5,000 to about 100,000 Barrer at 22° C.

12. A coated substrate, comprising:
a substrate; and
a coating on the substrate, wherein the coating comprises the cured product according to claim 10.

13. The coated substrate according to claim 12, wherein the substrate is porous and the coating is a membrane having a water vapor permeability of about 5,000 to about 100,000 Barrer at about 22° C.

14. A method of separating gas components in a feed gas mixture, the method comprising:
contacting a first side of a membrane comprising a cured product of a hydrosilylation-curable silicone composition with a feed gas mixture comprising at least a first gas component and a second gas component to produce a permeate gas mixture on a second side of the membrane and a retentate gas mixture on the first side of the membrane,
wherein the permeate gas mixture is enriched in the first gas component and the retentate gas mixture is depleted in the first gas component,
wherein the hydro silylation-curable silicone composition comprises
(A) an organohydrogenpolysiloxane comprising siloxane units, wherein about 20 to about 99.99 mol % of the siloxane units are bound to at least one trialkylsilyl substituted organic group and about 0.01 to about 30 mol % of the siloxane units are bound to at least one silicon-bonded hydrogen atom, wherein the organohydrogenpolysiloxane has a number-average molecular weight of about 3,500 to about 100,000 g/mol;
(B) a compound having an average of at least two aliphatic unsaturated carbon-carbon bonds per molecule selected from
(i) at least one organo silicon compound having an average of at least two aliphatic unsaturated carbon-carbon bonds per molecule,
(ii) at least one organic compound having at an average of at least two aliphatic unsaturated carbon-carbon bonds per molecule, and
(iii) mixtures comprising (i) and (ii); and
(C) a hydrosilylation catalyst;
wherein the ratio of the moles of silicon-bonded hydrogen atoms in Component (A) to the sum of the number of moles of aliphatic unsaturated carbon-carbon bonds in the composition is about 0.1 to about 20, and the membrane has a water vapor permeability of about 5,000 to about 100,000 Barrer at about 22° C.

15. The method of claim 14, wherein the feed gas mixture comprises carbon dioxide and nitrogen.

16. The method of claim 14, wherein the feed gas mixture comprises air and water vapor.

17. The method of claim 1, wherein the organopolysiloxane has a linear structure.

18. The unsupported membrane of claim 12, wherein the membrane has a thickness of about 0.1 μm to about 200 μm.

19. The unsupported membrane of claim 12, wherein the membrane is selected from a plate membrane, a spiral membrane, a tubular membrane, and a hollow fiber membrane.

20. The coated substrate of claim 12, wherein the porous substrate is a frit comprising a material selected from glass, ceramic, alumina, and a porous polymer.
